(19) United States
(12) Patent Application Publication
(10) Pub. No.: US 2009/0308571 A1
(43) Pub. Date: Dec. 17, 2009

(54) Heat transfer assembly and methods therefor

(75) Inventors: Brian E. Thompson, London (CA); Qijun Yu, London (CA); Joseph Daniel Bariault, Seattle, WA (US); Anthony G. Straatman, Thorndale (CA); Paul Redman, London (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Thermal Centric Corporation, London (CA)

(21) Appl. No.: 12/387,819

(22) Filed: May 6, 2009

Related U.S. Application Data
(60) Provisional application No. 61/114,036, filed on Nov. 12, 2008.
(60) Provisional application No. 61/086,758, filed on Aug. 6, 2008.
(60) Provisional application No. 61/084,405, filed on Jul. 29, 2008.
(60) Provisional application No. 61/083,060, filed on Jul. 23, 2008.
(60) Provisional application No. 61/052,134, filed on May 9, 2008.
(60) Provisional application No. 61/052,143, filed on May 9, 2008.

(51) Int. Cl. F28F 7/00; F28F 13/00; F28D 15/00; B23P 19/04

(52) U.S. Cl. 165/79; 165/135; 165/104.34; 29/700

(57) ABSTRACT

Embodiments in accordance with the present invention relate to heat exchangers, and more specifically to graphitic foam (GF) heat exchanger assemblies developed for a plurality of thermal management applications including the management of heat from electronic components, primary engine cooling and energy recovery. According to certain embodiments, these assemblies are designed using a pressure normal to the GF exchange element to ensure thermal contact without the use of bonding materials or methods. The bondless assembly is designed to be resistant to high thermal stresses and large thermal expansion coefficient differences thereby achieving and maintaining the highest possible thermal performance.

### CROSS-REFERENCE TO RELATED APPLICATIONS

The instant nonprovisional patent application claims priority to the following U.S. Provisional Patent Applications, each of which is incorporated by reference in its entirety herein for all purposes: U.S. Provisional Patent Application No. 61/052,134, filed May 9, 2008; U.S. Provisional Patent Application No. 61/052,143, filed May 9, 2008; U.S. Provisional Patent Application No. 61/083,060, filed Jul. 23, 2008; U.S. Provisional Patent Application No. 61/084,405, filed Jul. 29, 2008; U.S. Provisional Patent Application No. 61/086,758, filed Aug. 6, 2008; and U.S. Provisional Patent Application No. 61/114,036, filed Nov. 12, 2008.

### BACKGROUND OF THE INVENTION

Efficient thermal energy exchange is vital for today's microelectronic devices. As these devices continue to be reduced in size, power density and heat generation from these devices also increases. To manage this issue, heat transfer devices haven been utilized as attachment members to electronic devices in order to control dissipation of surplus heat.

Conventional heat transfer devices and assemblies generally include a metal block, machined or extruded fins that are then bonded to a metal plate, a heat spreader, or a tube that is in direct contact with a heat generating component. Thermal contact between the heat transfer device and the primary surface of the heat generating component is ensured by creating a conformal physical bond layer there between. Methods for bonding metal, metal foam, and graphitic foam (GF) elements include welding, soldering, or adhesives.

However, permanent or semi permanent bonding inherently causes local stresses at the interface, which are dictated mainly by the divergence in the effective thermal expansion coefficient (TEC) between the parts, thereby effectively limiting the design of thermal transfer devices to materials with similar TEC. Such physical bonding also results in excess processing stresses and overall assembly complexity and cost.

With higher density per area per die of integrated circuits (ICs), and more die per area on assembly boards, heat removal becomes an engineering challenge. To address this issue of thermal management, heat sinks and heat pipes are used to remove waste heat. In heat transfer devices where size, weight, and efficiency are critical parameters, the surface area per volume, the material density, and the thermodynamic properties of the material become increasingly important factors, limiting fabricated (machined or manufactured) fins and extended surfaces due to the strict limitations on the amount of heat managed. The thermal conductivity of typical heat transfer materials also limits the amount of heat managed within a given volume.

Performance, efficiency, and cost of thermal exchanger assemblies and thermal management devices depend on the transfer element material utilized, the assemblies' complexity, and ultimately its capacity for thermal energy exchange. Heat dissipation and waste heat management are an integral part of microelectronic device design criteria. Furthermore, the development of highly effective heat exchangers is sought to efficiently conserve and recover energy from engines and combined heat and power cycles.

Electronic component heat sinks and similar components, typically include approaches for removing heat from the source utilizing enhanced surface area mechanisms. Examples include but are not limited to machined or formed metal fins, and forced or natural convection of cooling liquids. Heat sinks are typically made of a good thermal conductor such as copper or aluminum, so heat can be transferred through the structures to be convected away by the passing fluid.

Heat exchangers may be used to transfer heat energy from one fluid to another. In common use, metal heat exchangers are utilized to minimize the conductive resistance between the fluids and the materials they interface with.

Conventional heat transfer devices and assemblies generally include a metal block, machined or extruded fins bonded generally to a metal plate, a heat spreader, or a tube that is in direct contact with a heat-generating or carrying component. To improve upon conventional designs, metal foam has been used in place of the extended surface devices as a convection element, with a higher surface area to volume ratio. This reduces both the volume and the weight of the heat transfer device or assembly.

Certain advances have addressed and improved upon many thermal impedance parameters. In order to reduce specifically the Thermal contact (or joint) impedance bonding methods for metal, metal foam, and graphitic foam (GF) elements or subassemblies have been developed including welding, soldering and adhesives to metallic or other highly thermal conductive structural or mechanical surfaces which use graphitic foam as a heat sink in applications that require the shielding from a heat source.

Acceptable thermal contact is ensured by creating a conformal physical bond layer between the heat generating or carrying components primary mounting surface and the heat transfer or dissipating components attachment surface. This permanent or semi permanent bond inherently causes local stresses at the interface, which are dictated mainly by the divergence in the effective thermal expansion coefficient (TEC) between the parts thereby effectively limiting the design of thermal management systems to materials with similar TEC. This physical bonding also results in excess processing stresses and overall assembly complexity and cost.

To minimize these problems thermal interface materials (TIM) and thermal greases (TG) have been developed almost exclusively for the case of the microelectronics industry. TIMS and TG minimize voids and improve the coupling between heat sinks and heat generating devices. Many of these interface materials however have difficult rework parameters, early breakdown characteristics upon thermal cycling, and are not easily cleaned off of the primary application surface without solvents. Moreover these materials are separate additions required for improved operation of the thermal exchange devices described.

FIGS. 1 and 2 show conventional extended-surface heat sinks which are commonly made of good thermal conductors, such as copper or aluminum so that heat from the hot component can be readily transferred through the solid structure, entrained, and convected away by a cooling fluid. Forced convection from a fan or blower is generally used to increase the temperature gradient between the air and the heated surface and thereby increase the convective heat transfer coefficient.

In order to address heat transfer challenges, recent developments include devices that use high porosity reticulated aluminum, copper and titanium foams to enhance the surface area. The enhanced surface area reduces the convective resistance in heat transfer devices and overcome the limitations on available surface area per unit volume and avoid complicated machining or manufacturing processes.

However, the use reticulated metal foam heat sinks is limited by high porosity (90-95%), low surface area to volume ratio, and (relatively) low solid phase conductivity. These characteristics lead to low effective conductivities which render the metal foams ineffective except for very thin layers adjacent to the heat source thereby severely limiting the practical utility of these configurations.

Graphitic foam (GF) has been recognized as an alternative to reticulated metal foams. GF has moderate porosities (75-90%), higher surface area to volume ratios (5,000-50,000 m²/m³) and much higher solid phase conductivities (up to 1900 W/m K) than the reticulated metal counterparts. Therefore, GF can raise the maximum heat dissipation limit considerably.

Thus far, little attention has been paid to the shape of the graphite foam elements or the hydraulic performance of said shapes as rectangular blocks or fin shaped elements, thus full advantage of the internal surface area of the GF may not be taken advantage of. GF fins may are machined into a dense graphite foam (90% dense) block and soldered to a copper spreader plate that is in thermal contact with a heat generating component. As with other conventional finned heat sink structures, air is required to blow over the structure. Such approaches generally lead to very high hydraulic losses and relatively poor thermal performance. However, because of the low density of the graphite foam material, the heat sinks can be much lighter than existing heat sinks made of extended metal surfaces.

Accordingly, there is a need in the art for improved approaches for fabricating heat sink structures.

### BRIEF SUMMARY OF THE INVENTION

Embodiments of the present invention generally relate to thermal exchangers. Certain embodiments relate to the use of thermally conductive open cell graphitic foam (GF), GF composites, and GF functionalized materials, for producing bondless thermal exchange assemblies with good conductive exchange, high convective exchange, high thermal stress tolerance, and low interface stresses.

Embodiments of the present invention employ heat transfer assemblies with GF materials that are used to overcome the limitations of surface area per unit volume, reliability of braze or weld, interface stress due to thermal expansion coefficient difference, and repeatability of heat transfer assemblies.

An embodiment of the present invention offers a plurality of bondless GF heat exchange assemblies (GFA) for thermal management, which provide efficient heat exchange with tolerable variation in thermal contact impedance and low sheer stress at device interface. These heat exchange assemblies are capable of being a replaceable solution for environments which foul GF materials. The embodiments specified herein mainly target the transference of heat energy to or from high power electronic systems, engines, and other devices, while providing high effectiveness for heat recovery devices.

Embodiments of the heat exchange assemblies are designed to take the place of metal fins, foam heat transfer devices and hybrid systems. The use of GF assemblies as a replacement for conventional heat exchange devices reduces the overall weight and assembly complexity of the heat transfer devices as it eliminates the required bonding or brazing interfaces.

An objective of particular embodiments of the present invention to provide GFAs with tolerable thermal contact impedance by applying a compression force with a component generally normal to the heat exchange surface the foam is contacting.

An objective of embodiments of the present invention is to provide a high surface area to volume ratio (As/V) heat transfer assemblies for convective heat transfer for increased efficiency thermal management devices and methods for producing the same.

An objective of embodiments of the present invention is that said GFAs will be comprised of a single or a plurality of layers such that sufficient solid material exists for the required thermal exchange.

An objective of embodiments of the present invention is to provide GFA which are resistant to instantaneous thermal shock or prolonged thermal cycling.

An objective of embodiments of the present invention to provide as GFA that are much lighter and produced at reduced costs as compared to conventional heat transfer assemblies.

An objective of embodiments of the present invention is to create GFA simple assemblies where the heat exchange element can be readily and easily replaced.

An objective of embodiments of the present invention is to minimize the sheer stress at the interface at the thermal junction by taking advantage of the self lubricating nature the graphitic surface.

In order to achieve one or more of the objectives set above, according to an embodiment of the present invention, a thermal exchange assembly is provided comprising at least one thermal transfer GF core element having pressure in directions normal to the transfer surface. At least one GF element is used per layer in a single, multiple, adjacent, or nested configuration, producing the internal surface area to achieve the temperature differential required. The GFA may include a single or plurality of lateral or stacked segments, which may be similarly or dissimilarly composed or shaped, and which generally extend to generally cover at least one heat exchange area. The thermal contact impedance of the GF elements and the material reliability of these is largely independent of the thermal gradient near the junction and mostly a function of the GF bulk material properties and the ligament contact load at the GF element and heat exchange surface interface.

An embodiment of the present invention relates to a heat sink made from graphitic foam (GF) based materials, and developed for thermal management applications, e.g. removing heat from an integrated circuit. The heat sink includes an integrated heat spreader, a GF based element, and a forced convection source, operably connected together.

Embodiments of the present invention relate to heat sinks. Particular embodiments utilize heat sinks made out of graphitic foam (GF) materials in the construction of a highly effective management of waste heat. Embodiments of the present invention take full advantage of the properties of GF to produce heat sinks that have a high thermal capacity while being compact and lightweight.

Embodiments of the present invention employ graphite foam material for a heat sink that is comprised of a high-conductivity porous foam element operably joined and in good thermal contact with a high-conductivity spreader plate, and a forced convection source. Several element shapes may be designed to take the best advantage of the available internal surface area, while yielding good efficiency and tolerable hydraulic losses.

Embodiments of the present invention relate to a heat sink concept for the thermal management of electrical and electronic components. Embodiments of the present invention provide for efficient heat exchange with low thermal resistance and with low overall volume and mass, as compared to conventional extended-surface heat sinks.

An embodiment of a heat dissipation structure in accordance with the present invention comprises a heat-generating component held in thermal contact with a heat spreader, which is joined to or a part of the graphite foam (GF) element. The heat spreader may be joined to the GF element utilizing pressure bonding only, or using an intervening material. A device such as a fan or blower forces convection directly through the structured material of the GF elements as described herein.

Due to its moderate porosity and high solid phase conductivity, the GF elements foster the entrainment of heat deep into the material. Its high area-to-volume ratio (5,000-50,000 m²/m³) and low material density fosters the creation of lightweight and convectively efficient heat sinks. These unique characteristics of GF material, in conjunction with the hydraulic design considerations, provide a balance of conductive and convective heat transfer which allows the development of heat sinks with much higher heat transfer performance than with metallic foams. Though particular embodiments utilize GF for the heat transfer elements, any conductive, interconnected porous material could be used without departing from the spirit and scope of the present invention.

An objective of embodiments of the present invention to provide a heat sink system that utilizes graphite foam material as a heat transfer element to enhance convective heat transfer.

Another objective of embodiments of the present invention is to provide a heat sink system that has a high heat dissipation capacity.

An objective of embodiments of the present invention is to provide a heat sink system that has a high ratio of heat transfer capacity to weight.

An objective of embodiments of the present invention to provide a heat sink wherein the heat transfer element is held in good thermal contact to the spreader plate without the need for mechanical bonding.

An objective of embodiments of the present invention is to produce forced air convection to the heat sink by using a forced convection device.

Embodiments of the present invention relate to a heat transfer assembly for facilitating thermal exchange. In particular, certain embodiments provide a heat sink structure having a bondless cooling element that is clamped in a secured position using clamping mechanisms fixed along opposite sides of the cooling element. Embodiments of the present invention are capable of providing heat sinks that have a high thermal capacity while being compact and lightweight.

The clamping mechanisms of embodiments of the present invention include metal clamps and a spring mechanism capable of exerting sufficient clamping pressure on the cooling element. Particular embodiments of the present invention include aerodynamic clamp flaps configured to protect the cooling element from mechanical damage and also direct flow onto the cooling elements with minimal energy loss.

These and other embodiments of the present invention, as well as its features and some potential advantages are described in more detail in conjunction with the text below and attached figures.

### BRIEF DESCRIPTION OF THE DRAWINGS

FIGS. 1a, 1b, 1c and 1d describe the basic planar structure of a characteristic heat transfer assembly, the preloaded interface for conductive heat exchange and the loaded interface respectively;

FIG. 2a shows an elevational cross-section of rendition of a single GF element layer with a volumetric recess area in thermal contact with an exchange surface and compressed by a open attachment mechanism whereby cooling fluid enters;

FIG. 2b shows an isometric view of a single GF element layer in thermal contact with a flat plate attachment mechanism whereby cooling fluid enters parallel to the heat exchange surface;

FIG. 3 shows an elevational cross-section of rendition for a multiple GF element layer in thermal contact with a varying size heat sources and both flat and open attachment mechanisms with and without volumetric recesses on and for the heat exchange elements;

FIGS. 4a and 4b show elevational cross-sections of rendition of stacks of heat exchange elements and a plurality of compression schemes to achieve required thermal contact;

FIGS. 5a and 5b show respective elevational cross-sections of rendition of characteristic loaded interfaces with one and with more than one cooling fluid paths between components of an exemplary heat transfer assembly.

FIG. 6 shows an example of a conventional plate fin heat sink that can be used in either natural or forced convection to remove heat from an electronic component.

FIG. 7 shows an example of a conventional pin fin heat sink that can be used in either natural or forced convection to remove heat from an electronic component.

FIG. 8 shows a cut-away drawing of the nested centrifugal fan heat sink configuration according to an embodiment of the present invention.

FIGS. 8a and 8b show two isometric drawings of exemplary heat sink configurations according to an embodiment of the present invention.

FIGS. 9a-c show three other embodiments of exemplary heat exchange elements that can be used with the heat sink configuration shown.

FIG. 10 shows an isometric drawing of an axial fan stacked heat sink configuration.

FIG. 11 shows a perspective view of the heat sink structure having clamping mechanisms arranged along its longer sidewalls according to a first embodiment of the present invention.

FIGS. 12(a)-12(d) show different views of the heat sink structure according to the first embodiment of the present invention.

FIG. 13 shows a perspective view of the heat sink structure having two clamping plates arranged along its shorter sidewalls according to a second embodiment of the present invention.

FIGS. 14(a)-14(d) show different views of the heat sink structure according to the second embodiment of the present invention.

FIG. 15 shows a simplified schematic view of a conventional thermosyphon structure.

FIG. 16 shows a simplified schematic view of an embodiment of a thermosyphon structure according to the present invention.

FIG. 17 shows a simplified schematic view of an alternative embodiment of a thermosyphon structure according to the present invention.

FIG. 18 shows a simplified schematic view of another alternative embodiment of a thermosyphon structure according to the present invention.

FIG. 19 shows a simplified schematic view of another alternative embodiment of a thermosyphon structure according to the present invention.

FIG. 20 plots thermal resistance versus heat dissipation for the embodiments of FIGS. 2-5.

FIG. 21 plots CPU case temperature versus heat dissipation for the embodiments of FIGS. 2-5.

FIG. 22 shows a simplified schematic view of a further alternative embodiment of a thermosyphon structure according to the present invention.

FIG. 23 is a simplified perspective view showing porosity of one embodiment of a carbon foam in accordance with the present invention.

FIG. 24 is a simplified perspective view showing porosity of another embodiment of a carbon foam in accordance with the present invention.

FIG. 25 is a simplified perspective view showing porosity of an embodiment of an optimized carbon foam in accordance with the present invention.

FIG. 26 is a simplified cross-sectional view of an embodiment of an apparatus in accordance with the present invention for optimizing a porous material.

FIG. 27 is generic representation of a unit cube model of foam behavior.

FIGS. 27A-E plot a number of properties versus porosity, predicted by the unit cube model.

FIG. 27F is generic representation of a the unit cube of a conventional carbon foam.

FIG. 28 plots ideal window diameter/pore diameter versus porosity for certain carbon foams.

FIG. 29 is a simplified diagram showing the steps of a process flow for optimizing a porous graphitized-conductive foam material.

FIG. 30 plots Nusselt number versus pressure drop for certain carbon foams.

FIG. 31 is a photograph showing conventional finned heat sink structures made from steel (left) and copper (right), and shows an embodiment of a heat sink structure in accordance with the present invention made out of dense GCF material (center).

FIG. 32 shows the thermal performance of finned heat sink structures having fins made from various materials (metals, dense GCF foam).

FIG. 33 shows estimates of thermal performance for various GCF heat sink structures.

### DETAILED DESCRIPTION OF THE INVENTION

In the following detailed description, reference is made to the accompanying drawings which for a part hereof, and in which is shown by way of illustration are specific embodiments only, and are not intended to limit the scope of the present invention. The illustrative examples for thermal transfer achieved through the utilization of the assemblies and methods according to embodiments of the present invention, rely on reducing the thermal contact impedance between a heat generating or containing surface and the heat transfer assembly structure. The embodiments illustrate approaches to manufacturing a thermal exchange assembly which can quickly transfer heat away from a high concentration heat source. Such examples are by no means limiting in scope, in that a wide variety of materials and configurations are contemplated for use. These embodiments described in sufficient detail to enable those skilled in the art to practice the invention, and it is to be understood that other embodiments may be utilized and that structural changes may be made without departing from the spirit and scope of the present invention.

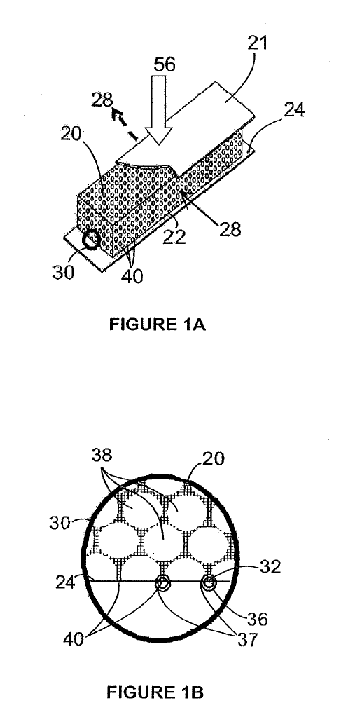

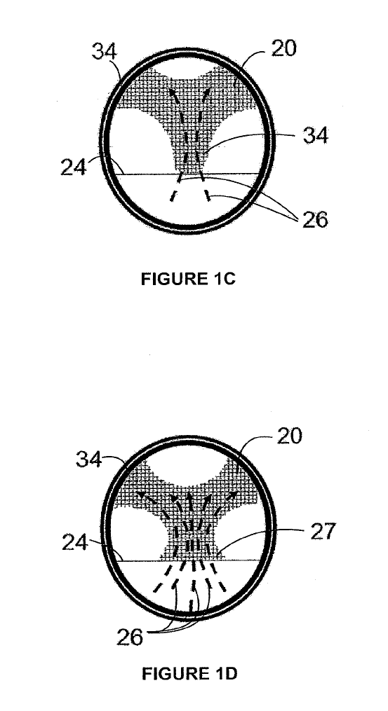

The exemplary embodiments of a heat exchange assembly constructed in accordance with one embodiment of the invention, as illustrated in a partial cross section in FIGS. 1a, 1b, 1c and 1d of the accompanying drawings, illustrates how this heat exchange assembly operates. As referenced in FIG. 1a, a heat exchanger block of graphitic foam 20 is in thermal contact 22 with a heat exchange surface 24 through compression of the foam 20 with an attachment mechanism 21 onto said exchange surface 24 thereby entraining the heat energy of the source into the foam in a direction mainly perpendicular 26 to the local exchange surface 24, said heat energy is to be then convected away by a cooling fluid 28 flowing in contact with the GF element 20. This figure's isometric view is shown and an amplification of the interface 30 of interest is shown in FIG. 1b.

In this case direct bonding through soldering, active brazing, or simple brazing is avoided by creating a acceptable thermal junction 22 with tolerable thermal contact impedance by the compression of the GF material 20 against the thermal exchange surface 24 thereby saving time, cost, and complexity as compared to the current art methods. This modular and bondless design permits the assembly to have removable and replaceable GF elements 20.

FIGS. 1b, 1c and 1d illustrate amplified cross-sectional views of the contact interface 22 between the exchange surface 24 and its graphitic foam material heat exchange element 20 with graphitic ligament structure before 32 and during 34 loading respectively. In both these cases the GF based heat exchange element 20 can be used without having to match with the coefficient of thermal expansion (CTE) of the exchange surface 24 material providing thus reduced interfacial stresses caused by any CTE mismatch as no bonding exists, thereby attaining an assembly resistant to damage due to thermal spikes of rapid thermal cycling.

In FIG. 1b the exchange surface 24 may have one 36 or more 37 thermal sources and may house a multiplicity of exchange locations each associated to single or multiple heat sources. The thermal exchange element 20 and the heat source or exchange surface 24 may be considered as being a unit module or a portion of a unit module which is to be cooled. In this figure, it is also represented that the graphitic foam 20 having a average cell or void density and cell size 38 may have these hollow or filled with fluids including gas or phase change materials, while cells 38 may be spherical, ellipsoid, or capsule-shaped.

In FIG. 1c, prior to the foam element 20 being compressed against the exchange surface 24, they make mechanical contact at numerous points 40 with a distance relative to the surface graphitic ligaments 42 which are aligned by their graphitic structure and generally spaced by the pore dimension 38 of the material. The heat exchange surface 24 or the apparent area covered by the element's contacting surface is the projection of all real contacting points on the plane normal to the direction of the applied load, thus the real contact area is always less than, or at its limit, equal to the apparent area. The load at which plastic yield begins in the contact of two solids, is related to the yield point of the softer material, in this case the GF element. Under the applied load, the GF ligament, connection points, then deform 27 to support the load, thereby the area of contact is proportional to the applied load. As the applied load increases, the surface localizes the applied pressure at these points of contact thereby increasing the effective load and contact area thereby decreasing thermal contact impedance linearly as the thermal contact impedance approaches the bulk resistance of the material as the system moves to relatively high loads. This phenomenon leads to a relatively high temperature drop across the interface as thermal energy can be transferred deep in to the GF material until mechanical failure of the foam occurs at forces beyond 5 MPa.

In FIG. 1d contact ligament deformation is illustrated in accordance with the principles of this invention. As in this illustration, once compression is applied, the GF element 20 comes into thermal communication with the heat exchange surface 24 by being pressed at one or multiple points against said surface 24 with a force which would exceed the force needed for deformation of the touching ligaments 34 thereby increasing the micro-contact area and further approaching the total possible contact area.

The GF material in this embodiment provides an inherently low lateral stress at the heat exchange interface during any mechanical movement due to dissimilar thermal expansion as reduced friction exists provided surface lubrication of the graphite and relatively low wear of the operably connected surfaces as GF materials posses a lamellar crystal structure with a low shear strength and sustained thermal stability ensuring that the material will not undergo undesirable phase or structural changes during thermal cycling or thermal stressing.

The interconnected pore structure of the GF combined with the respective high solid-phase conductivity of the material fosters the entrainment of energy into the foam, while the internal surface area of the same, which should be in the range 1,000-50,000 [m²/m³] depending upon porosity, enables the effective exchange of energy with the cooling fluid. Solid-phase conductivities of up to 2000 [W/m·K] allows the production of foams with effective (stagnant) conductivities up to about 500 [W/m·K].

### EXAMPLES

### Example I

A first embodiment will be described by reference to the drawings. In this embodiment the heat transfer assembly as referenced in FIG. 1 comprises at lease one segmented, formed or simple block of graphite based foam 20 in thermal contact with the heat exchange surface 24 through direct compression of GF material 20 to said surface 24 creating an acceptable thermal junction 22 with a low and mostly temperature independent thermal contact impedance. During normal operations the heat in block is dissipated through convection by directing a fluid coolant 56 through the block 20 relative to the heat flow 58 at the surface, as seen in FIG. 1c.

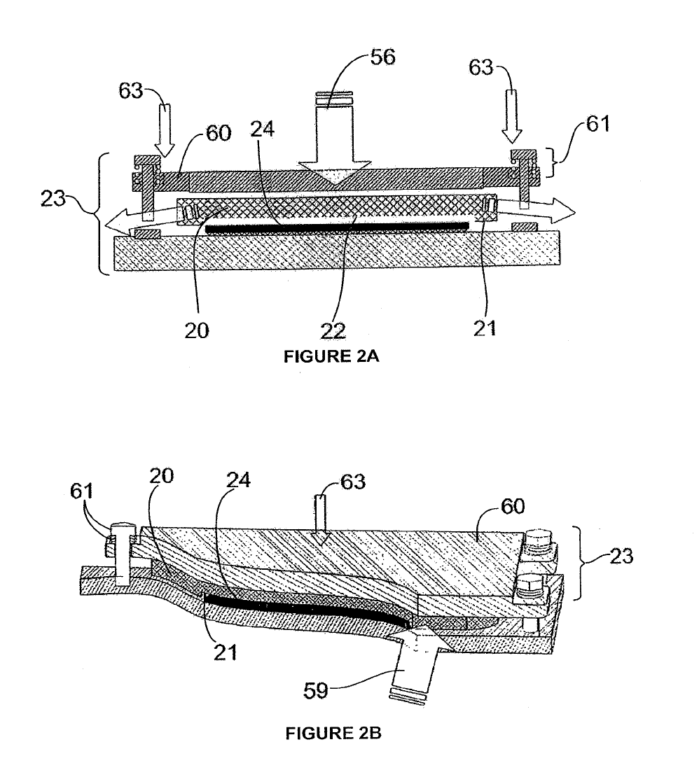

FIG. 2a illustrates an embodiment seen as a preassembled unit 23, having an element bottom contact surface 21 which can be modified by the addition of a volumetric recess for conformal connection to the heat exchange surface 24 topography. Here the foam element is operably secured to enable compression force 63 by means of an exemplary mechanical attachment mechanism 60 which comprises a handling open frame around the element and spring loaded posts 61. Said attachment mechanism can be a circular, square-shaped, or correspondingly element shaped metal, ceramic or plastic in a open or closed configuration structure which maintains the desired pressure on the GF material 20 against the heat energy containing surface. The attachment mechanism 60 can be a carrier, frame, latch, spring loaded plate or frame, or other mechanism which provides a convenient way for handling compression while maintaining dimensional stability for the thermal exchange assembly structure fabricated thereon. In this embodiment the cooling fluid flow 56 can be from the top in the case there is an open access or from the side 59 otherwise as in FIG. 2b.

### Example II

A second embodiment of the invention will be described by reference to the drawings, and the structure of a thermal heat exchange assembly according to this embodiment will be described in terms of manufacturing steps.

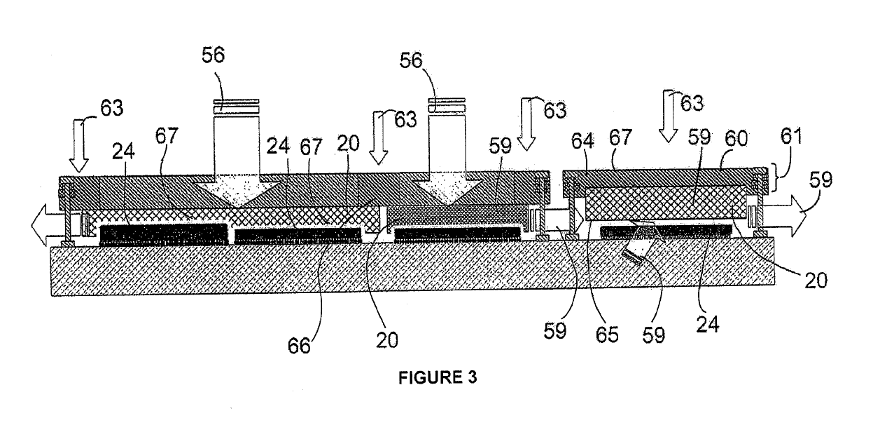

FIG. 3 shows an embodiment which may include several GF elements 20 being coplanarly located in one or more axial directions sequentially forming a multielement layer 62. Said element layer 62 can be connected by separate 64 or common mechanical attachment mechanisms 66, wherein the GF material layer 62 is sandwiched between the heat exchange surface 24 and the attachment mechanism 60. Any or all of the elements, surfaces and mechanisms may 67 or may not 65 have a volumetric recess for conformal connection of the parts through geometrical or alignment topography.

With reference to FIG. 3, a heat exchanger GF element assembly may have varying densities of GF 20 in order to match varying heat dissipation requirements on the surface of the module. Additionally, differing sizes or shapes may be utilized to achieve the required thermal or structural compliance. Further, because of the adjustable level of porosity per element, material characteristics can be chosen to maximize conductivity and cooling capability of the assembly.

### Example III

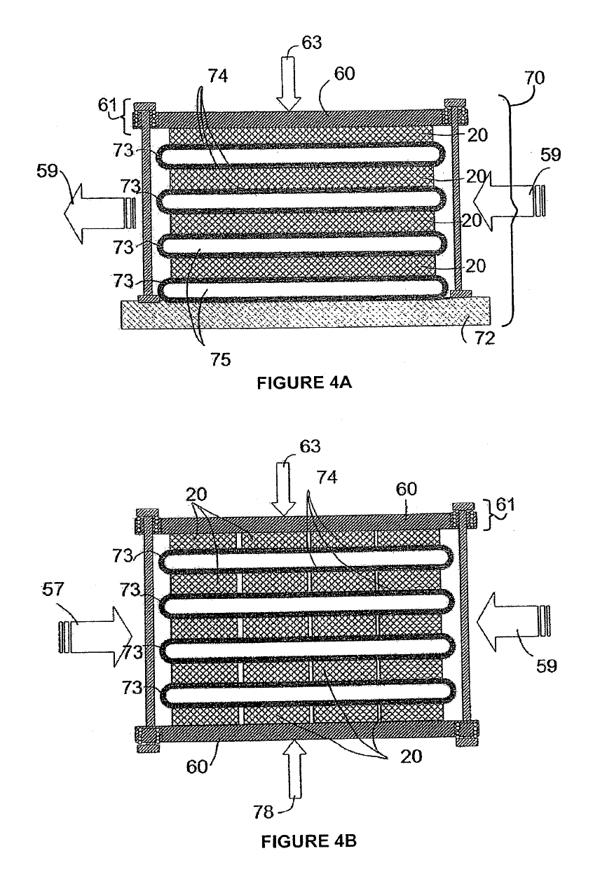

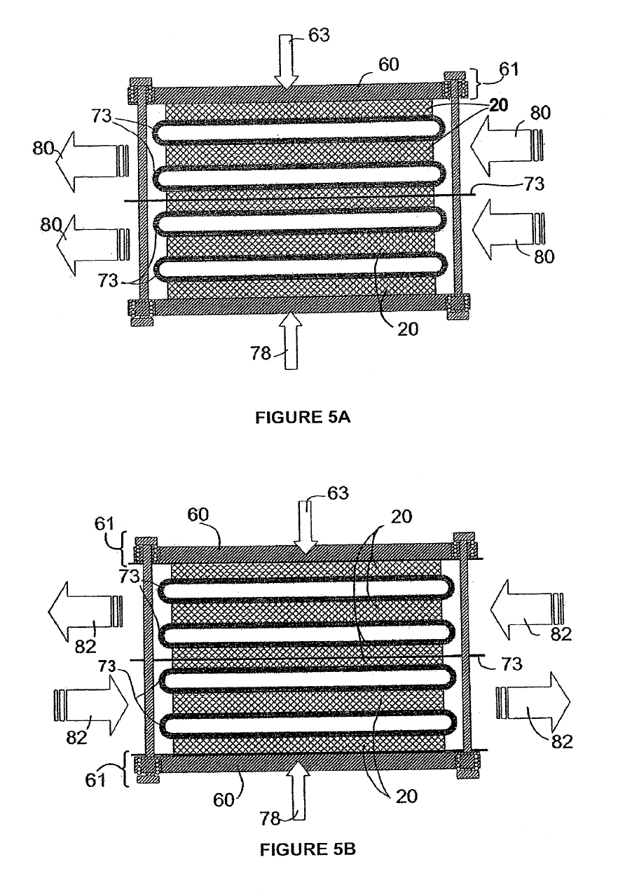

Further embodiments of the present invention are illustrated in FIGS. 4 and 5 which explain a third embodiment of the invention is described as a stacked multilayer heat exchange assembly formed by alternating foam element layers and barrier layers which are effectively sandwiched between the heat exchange surface and the attachment mechanism.

This embodiment can exhibit several possible variations in relative size and geometry. The basic heat exchange mechanism of this element is identical with that of the first embodiment. This plurality of array elements must be stacked as to ensure proper compression on all layers, therefore the layout can contain alignment marks or features to simplify assembly and integration of the same.

FIG. 4a illustrates an exemplary stack 70 anchored to a base 72 whereby all the barrier layers 73 are also exchange surfaces 74, composed of flat tubes 75, only serve as a separating boundary for each element layer 20 and a separate mechanical attachment mechanism 76 compressing the assembly from the top against a reference base 72. Alternately many stacks 70 can be attached to one or more sides of said base 72. An alternate embodiment would have the barrier layers acting individually as attachment mechanisms to the base, top, or next barrier surface.

FIG. 4b has a variation whereby a stack 70 formation wherein a plurality of elements 20 is arranged in a matrix formation. Additionally here, as possible in various embodiment, the compression pressure is held from more than one force 78. In this embodiment compression is applied on the element stack 70 in two opposing directions parallel to the exchange surfaces 74. Furthermore more than one cooling fluid direction 57 can further improve versatility and thermal performance of the device by requirement or design.

FIGS. 5a and 5b illustrate stacked heat exchange assemblies 70 which can have either a single cooling fluid 80 or multiple cooling fluids 82 interacting with the elements in a predetermined manner. In these embodiments the separating barrier 73 could be a solid conducting layer, a flat tube, a fin or other separation mechanism. An alternate configuration could have any combination of the herein described GFA embodiment characteristics present in the stack 70. Another variation would be the utilization of differing porosity of composition GF foams or foams of differing thicknesses to alter the design or performance characteristics of the assembly as depicted in FIG. 3.

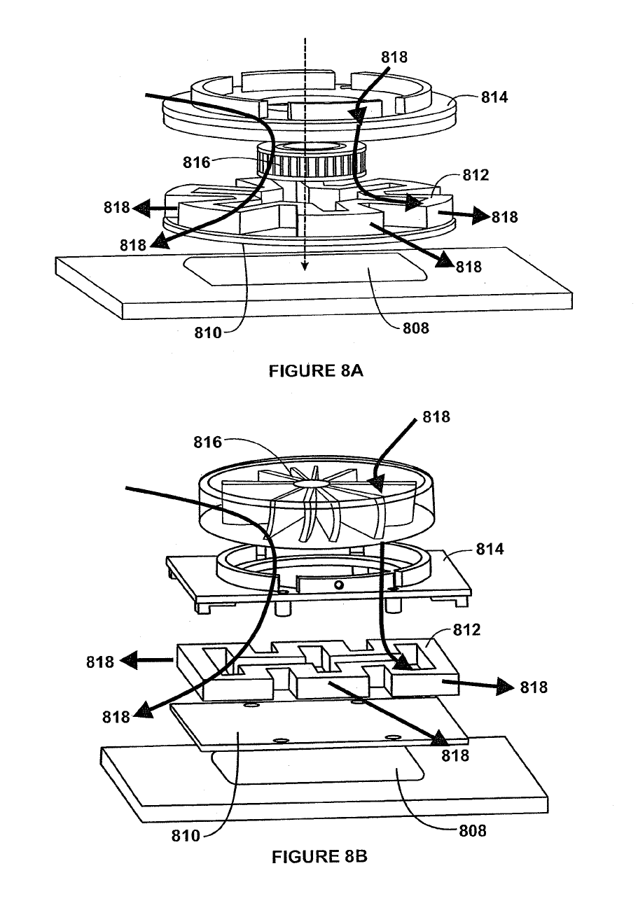

Certain embodiments of the present invention relate to heat sinks, and in particular to flow-through heat sinks for cooling applications. FIGS. 8-8b disclose the conceptual configuration of a heat sink that comprises a metal heat spreading plate 810, a GF heat transfer element 812, a device 814 for holding the foam element in thermal contact with the spreader plate, and a fan 816. FIGS. 8a-b shows two isometric views of the cut-away drawing in FIG. 8 to clarify the operation and function of the concept of the disclosed embodiments.

The GF element 812 has a closed-loop shape that forms a cavity. The foam element 812 is held firmly against the spreader plate 810 using either physical compression or a bonding method. As such, a good thermal contact is obtained between the GF element 812 and the spreader plate 810.

Heat from the electronic component 808 is conducted into the heat spreader plate 810 and then into the GF element 812. The fan 816 blows air 818 directly through the GF element 812 and thereby sets up a pressure differential as compared to atmosphere inside the cavity. This pressure forces air 818 into or out of the cavity setting up a constant flow rate of air across the fan motor, the cavity and through the thickness of the GF element 812 where heat conducted away from the electronic component is entrained and convected away. The spreader plate 810 shown in FIGS. 8-8b is a basic design and may be replaced by a more elaborate design that reduces the spreading resistance.

The embodiment disclosed in FIGS. 8-8b offers a large amount of surface area with the GF elements in a relatively small volume, thereby reducing the size of the heat sink while preserving or raising the thermal capacity. A second advantage of embodiments in accordance with the present invention is that the GF heat sink is considerably lighter than an equivalent extended surface metal heat sink because of the reduced size and lower density of the GF material over that of solid aluminum, copper or other metal.

Yet another advantage of the disclosed heat sink configuration is that the GF element 812 is not mechanically bonded to the heat spreading plate 810 or the holding device 814. Therefore, the heat sink can therefore be removed for cleaning, maintenance or replacement if significant fouling or plugging of the foam structure should occur.

Still another advantage of the GF heat sink is the nesting of the fan 816 in the GF element cavity. This configuration reduces the overall volume of the device, making it significantly more compact than any extended surface metal heat sink device that operates under forced convection.

The configuration disclosed in FIGS. 8-8b also has significant advantages over other heat sinks that utilize GF. First, by utilizing shaped elements to ensure the balance between thermal and hydraulic resistance, the desired heat dissipation is attained without excessive pressure losses. A second advantage is that the closed-loop element design ensures that heat is more uniformly distributed through the foam, that the airflow through the foam is more uniform, and allows nesting of the fan 816 to give a more compact heat sink assembly.

Yet another advantage of the heat sink configuration according to embodiments of the present invention, is that they can be made with no mechanical bonding requirements, thereby producing a good thermal contact between the spreader plate 810 and the foam element 812. In all known prior disclosures utilizing GF, the foam is bonded to a metal substrate using cold-setting solder, metallization, and hot-setting solder, thermal epoxy or some other form of mechanical bonding.

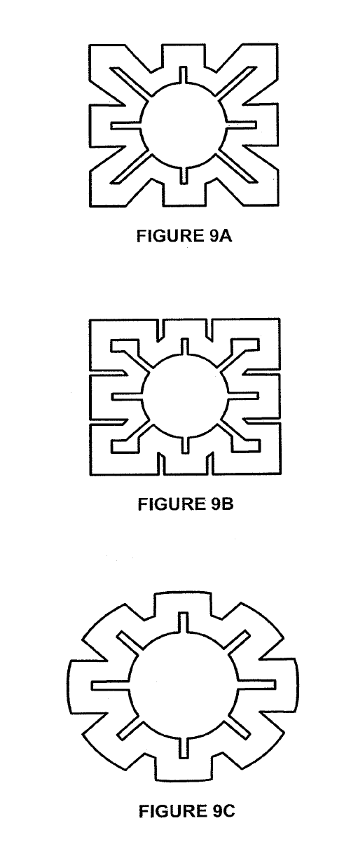

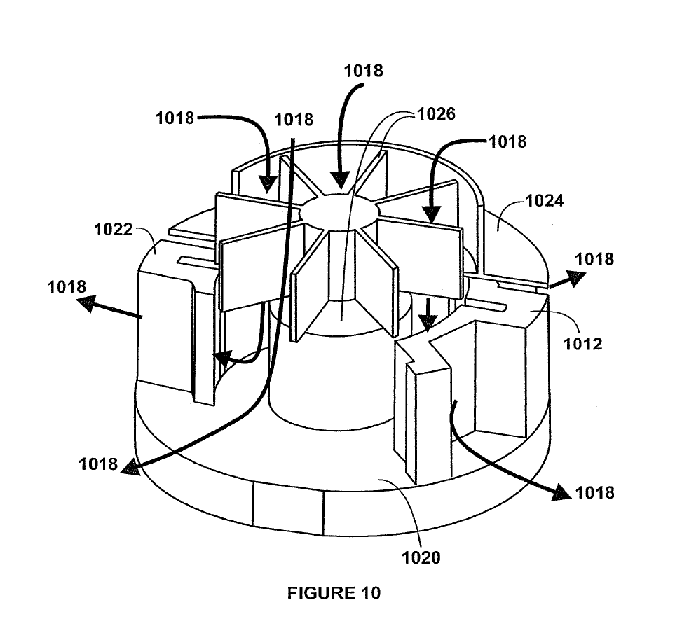

FIG. 9 shows plane view drawings of three exemplary GF element shapes that can be utilized with the heat sink configuration shown in FIGS. 8-8b and described in detail above. All GF elements depicted are closed-loop shapes that form a central cavity that can be pressurized by use of a fan or other pumping device. Alternate embodiments can have nested or open loop structures nested in an closed loop outer element. Essentially, the shape of the GF element can be devised to fit into several specified planar areas without reducing the thermal capacity of the heat sink device. However, if the cavity becomes too small, an axial fan must be used in place of the centrifugal fan shown in FIGS. 8-8b to achieve the correct air pressure and flow rate.

FIG. 10 discloses a second heat sink configuration that comprises a heat spreader plate 1020, a GF heat transfer element 1022, a device 1024 for holding the GF element 1012 in thermal contact with the spreader plate 20, and an axial fan and motor assembly 1026. The heat sink assembly operates in the same manner as the configuration shown in FIGS. 8-8b, except that the cavity is now pressurized with air using an axial fan 1026. The axial fan configuration is useful in applications where the cavity produced by the foam element is too small to nest both the fan and motor. In this configuration, a higher pressure can be maintained on the GF element cavity.

The advantages described with reference to the nested centrifugal fan heat sink device of FIGS. 8-8b, also apply to the axial fan design of FIG. 10. However, the axial fan design occupies slightly more volume due to protrusion of the axial fan from the GF cavity.

An additional advantage can be realized in the axial fan design by bonding or otherwise fabricating the device with a thin up to 3 mm layer of GF on the spreader plate. The thin layer of GF will dissipate heat to the impinging flow drawn in by the axial fan and thereby increase the thermal capacity of the heat sink. This thin layer must, however be operably joined to the spreader plate monolithically or through the utilization of any standard bonding technique.

The GF elements shown in FIGS. 8-10 may comprise a mesophase pitch-based GF, such as is described in U.S. Pat. No. 5,961,814 or U.S. Pat. No. 6,033,506, which are hereby incorporated herein by reference. Another GFC product which is suitable for use in the present invention is available from Poco Graphite, Inc. of Decatur, Tex. under the brand name PocoFoam™, described in U.S. Pat. No. 6,776,936, and hereby incorporated herein by reference.

Due to their open microcellular structure and interconnected network of highly aligned graphitic ligaments, such graphitic foam products have relatively low densities yet comparatively high thermal conductivities. For example, the PocoFoam™ GF product comprises a density of less than about 0.6 g/cm3 but an effective thermal conductivity of approximately 150 W/m·K. Consequently, these mesophase pitch-based graphitic foam products are comparatively lightweight, but have superior heat transfer characteristics. In addition, owing to their open, interconnected structure, such foam products comprise a large specific surface area. As a result, the transfer of heat from the GF to the cooling fluid is very efficient.

In the following detailed description, reference is made to the accompanying drawings which for a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the spirit and scope of the present invention.

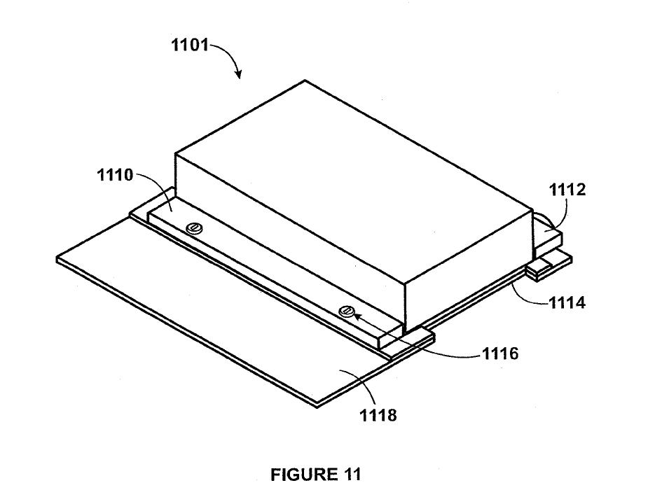

FIG. 11 depicts a perspective view of the heat sink structure according to an embodiment of the present invention. The heat sink structure 1101 comprises a metal heat spreading base plate 1118, clamps 1110 and 1112, spring mechanisms 1116, and a cooling element 1114.

The cooling element may 1114 may be a bondless GF based heat exchange element consisting of one solid piece of foam. Graphitic foam heat exchange elements provide efficient heat exchange with tolerable variation in thermal contact impedance and low sheer stress at the device interface. The embodiments specified herein mainly target the transference of heat energy to or from high power electronic systems, engines, and other devices, while providing high effectiveness for heat recovery devices.

As shown in FIG. 11, the clamps 1110 and 1112 are arranged along the two longer sidewalls of the cooling element 1112. Spring mechanisms 1116 are used to facilitate attachment of the clamps 1110 and 1112 with the heat spreading base plate 1118. Moreover, clamps 1110 and 1112 and spring mechanisms 1116 work together to form a clamping mechanism for cooling element 1114. Specifically, the spring mechanisms 1116 are configured to generate constant clamping pressure between the clamps 1110 and 1112 and the cooling element 1112. As such, good thermal contact is obtained between the cooling element 1112 and the spreading base plate 1118.

The spring mechanisms 1116 may be a screw only, a screw with a Bellville washer, a spring on a screw, or a lever mechanism. The lever mechanism generates the force evenly over the entire length of the clamps 1110 and 1112, while the springs on screws generate loads that are spread over the surface of the cooling element 1114. The insertion location of the spring mechanisms 1116 on clamps 1110 and 1112 is an important aspect of the embodiment. Two spring mechanisms 1116 are fixed to each clamp 1110 and 1112 at a position away from the cooling element 1114 and near the outer ends of clamps 1110 and 1112. This positioning is designed to apply a uniform force over long spans using only two hard points (four total spring mechanisms 1116).

Accordingly, the cooling element 1114 is held firmly against the base plate 1118 using physical compression from the clamping mechanisms including clamps 1110 and 1112 and spring mechanisms 1116. Thermal paste may or may not be used at the interface between the surface of the cooling element and the target heated surface. Furthermore, the heat spreading base plate 1118 is a basic design and may be replaced by a more elaborate design that reduces the spreading resistance.

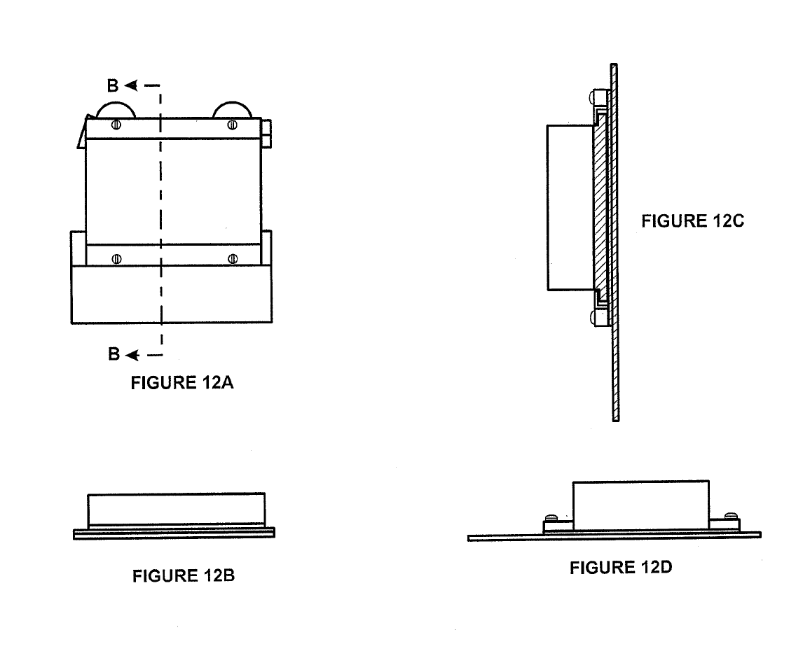

FIGS. 12(a)-12(d) show different views of the heat sink configuration of FIG. 1. Specifically, FIG. 12(a) is a top view, FIG. 12(b) is a front view, FIG. 12(c) is a vertical side view, and FIG. 12(d) is a horizontal side view of the heat sink configuration having clamping mechanisms arranged along the longer sides of a cooling element.

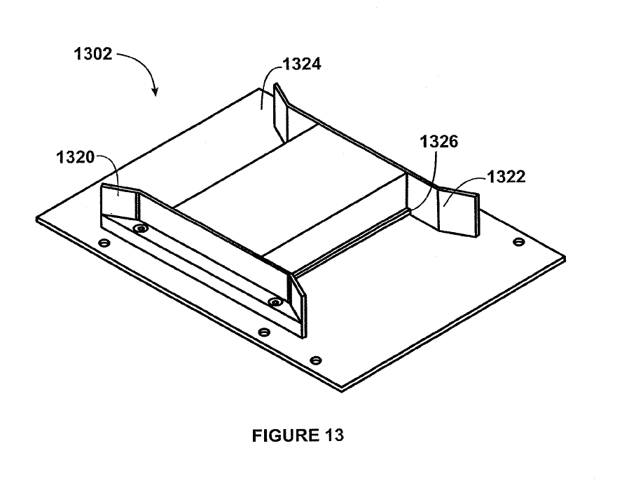

FIG. 13 shows a perspective view of another heat sink structure according to the second embodiment of the present invention. Like the first embodiment, the heat sink structure of FIG. 13 comprises a heat spreading base plate 1324, clamps 1320 and 1322 (including spring mechanisms for attachment to base plate 1324), and a cooling element 1326. In contrast to the heat sink configuration of FIG. 13, however, the two clamps 1320 and 1322 of the second embodiment are arranged on the shorter sidewalls of the cooling element 1326. Furthermore, the height of the clamps 1320 and 1322 is substantially equal to the height of the cooling element 1326. The aerodynamic design and flaps of clamps 1320 and 1322 are capable of directing heat flow onto the cooling element 1326 while minimizing energy loss. This design also serves to protect the cooling element from mechanical damage.

The four springing mechanisms are pressurized as in the first embodiment, and positioned on the flap clamps 1320 and 1322 at positions relative to the outer edges of the cooling element 1326. As a result, constant clamping pressure can be effectively maintained between the cooling element 1326 and the clamps 1320 and 1322.

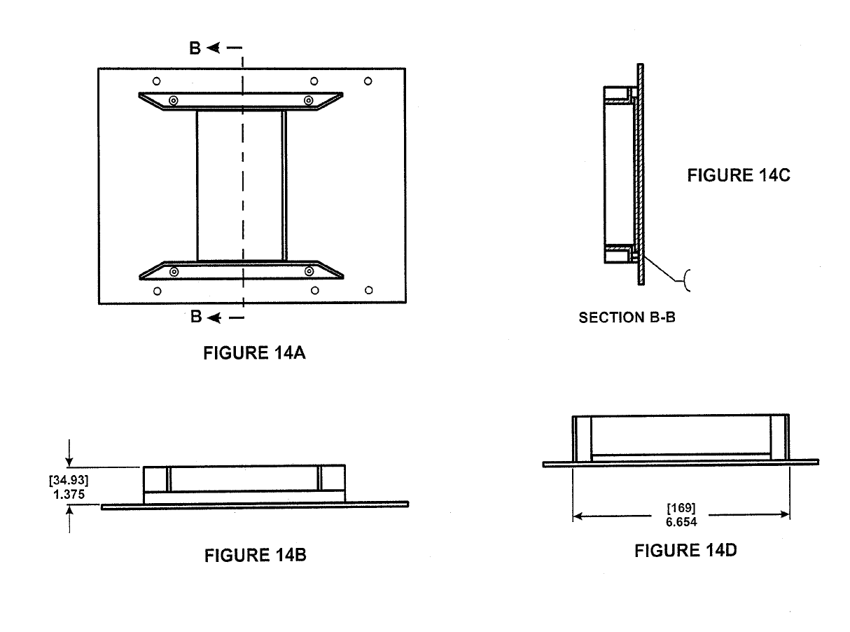

FIGS. 14(a)-14(d) show different views of the heat sink structure shown in FIG. 13. Specifically, FIG. 14(a) is a top view, FIG. 14(b) is a front view, FIG. 14(c) is a vertical side view, and FIG. 14(d) is a horizontal side view of a heat sink structure having clamping plates arranged along the shorter sides of a cooling element.

Additionally, the thickness of fins on the cooling elements can be varied for different operating environments in order to achieve efficient heat dissipation. For example, fins with a thickness between 0.017 to 0.035 inches can be used for stationary products like desktop computers with cooling gas flows at velocities below 2 m/s.

Also, fins with a thickness from 0.035 up to 0.045 inches are optimum for maximum surface area and minimal manufacturing costs. Such thickness is appropriate for cooling in all velocities of gas flow, and for cooling liquids flowing at up to 1 m/s. It is also applicable to flows with liquid droplets smaller than 100 microns. These fins are appropriate for applications with acceleration rates up to 10 g (10 times the acceleration rate of gravity) including those with fluctuating loads due to vibration.

Fins with a thickness larger than 0.045 inches are appropriate for cooling with any velocity of gas or liquid or combination thereof. Moreover, a fin thickness within this range are appropriate for any size of droplet traveling at speeds up to Mach 5, and also for applications with acceleration rates up to 200 g (200 times the acceleration rate of gravity) including those with fluctuating loads.

As mentioned previously, graphitic foam can be bonded to another element through the use of pressure. The thermal contact resistance is dependent upon the pressure applied to the contact area between the graphite foam component and the material to which it is being bonded. That material could be any material, including but not limited to metal, plastic, ceramic, or even another graphitic foam member having a similar or different composition and properties.

The magnitude of the contact pressure depends on a number of factors. One factor is the level of thermal contact resistance. Specifically, an increased contact pressure will decrease the amount of thermal contact resistance, and a low thermal contact resistance is generally desirable. However, the use of too great a pressure can result in a mechanical failure of the graphitic foam material attributable to physical stress.

In order to avoid the possibility of forming internal micro-cracks that break the internal pathways for conductive heat transfer through the foam, a pressure of some magnitude lower than the failure pressure of the material is typically used. According to certain embodiments, the maximum pressure that is applied is about 70% of the compression strength of the GF material.

For porous foam materials having compressive strengths of between about 0.96 and 3.56 MPa, maximum pressures have been used from about 0.67 to 2.49 MPa, respectively. For dense foam materials having compressive strengths of up to about 9.9 MPa, maximum pressures have been used up to about 6.9 MPa. These pressure levels have been applied with clamping mechanisms and levers to the base of finned elements for example those shown in FIGS. 11-14.

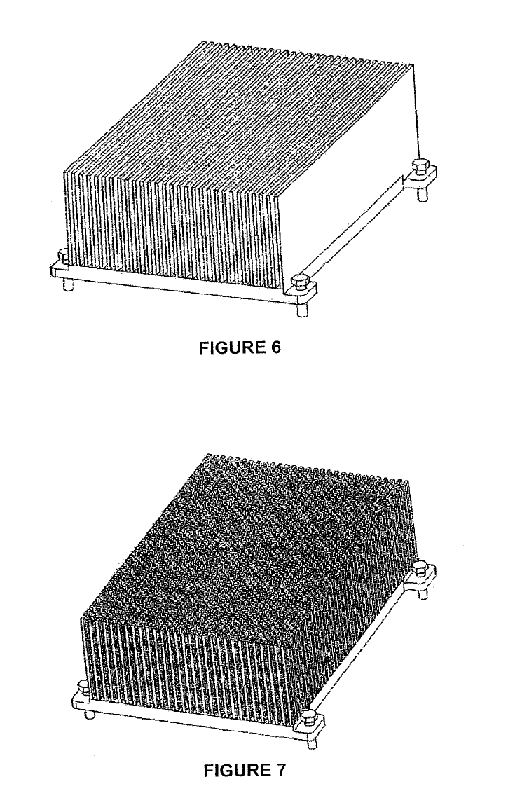

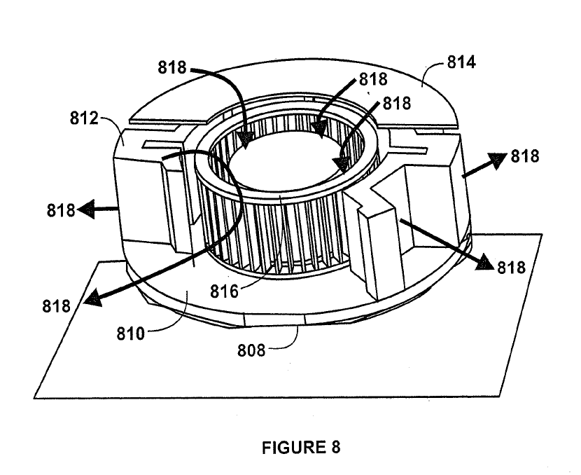

The minimum pressure that can be used depends on the particular application. Zero contact pressure yields infinite thermal resistance, which is undesirable. However, in some applications, the thermal resistance associated with the contact between the graphitic foam and the other element is not a significant factor. In such applications, low pressures may be employed. In general, however, contact pressures below about 30 KPa may exhibit a high enough thermal resistance so as to be impractical in many applications. The lowest pressures that have been used, were applied to finned components in clamping mechanisms similar to those shown in FIGS. 2, 3, 4, and 5, except that the porous foam is replaced with an array of finned GF elements such as is shown in FIG. 6.

Finned elements that are clamped between plates may fail in a buckling mode, at loads lower than the maximum compression strength of the material. For example, Table 1 shows the load at which buckling failure occurred for a range of fin thickness.

TABLE 1

| Fin thickness | Failure stress | Clamping loads applied |
|---|---|---|
| (Inches) | (psi) | (psi) |
| 0.020 | 20 | 14 |
| 0.030 | 60 | 42 |
| 0.040 | 134 | 93 |
| 0.050 | 250 | 175 |

In Table 1, five GF elements were tested to failure. The base of each test specimen was 1 inch by 1 inch by 0.090 inches, and the fins were 1.125 inches high. The spacing between the fins was 0.030 inches. The failure mode of all specimens was buckling.

In these cases and again to avoid the possibility of forming internal micro-cracks that break the internal pathways for conductive heat transfer through the foam, the maximum pressure that is applied is 70% of the buckling failure load for the GF fins. Fins thicker than 0.050 inches failed in compression, not in buckling.

The appropriate bonding pressure can be applied and maintained utilizing any number of techniques, employed alone or in combination. For example, the bonding pressure can be applied as a mechanical force, utilizing apparatuses including but not limited to clamps, springs, or levers.

Bonding pressure can also be applied and maintained utilizing other types of forces. Such forces can arise out of other phenomena, including but not limited to fluid pressures, pneumatics, hydraulics, hydrodynamics, aerodynamics, and atmospheric pressures.

In certain embodiments, the bonding pressure can arise from fluids that are utilized in temperature control, such as the pressure from a flow of air or water. In other embodiments, bonding pressure can be applied by other than the fluid utilized in temperature control, for example compressed air captured within an airbag.

The application of the bonding pressure need not be constant. For example, where thermal control is only required at certain times, the bonding pressure may be applied intermittently. For example, in some bearing applications, bonding pressure could be maintained only when needed, for example when a switch (for example for a light) was turned on. At other times, no pressure would be required. Similarly for a motor winding, bonding pressure could be applied when the motor was on and thus hot, but no pressure would be applied when the motor was off.

Apart from its failure characteristics, the properties of the graphitic foam element can also influence the location of the application of the bonding pressure. For example, the rigidity of a foam may allow for bonding pressures applied in only a few locations, to be translated globally across the graphitic foam element. Conversely, a foam that is not rigid may require the application of a more global bonding pressure.

The use of pressure bonding of a graphitic foam element, may offer significant advantages over conventional approaches requiring some sort of adhesion. For example, the use of pressure bonding accommodates differing rates of thermal expansion of a graphitic foam member versus that of other materials, such as plastic, metal, or ceramic. Because the graphitic foam material is not physically attached to the other material (for example by gluing or soldering), the two elements are free to expand or contract at different rates, while still remaining bonded to one another and allowing a flow of thermal energy. Moreover, the graphitic foam may function with natural lubrication properties, thereby enhancing its differential expansion/contraction relative to another material.

Use of Graphitic Foam Element to Enhance Boiling and Condensation

The market for electronic products is generally driven by the desire for higher performance and small size, and therefore typical power densities are constantly increasing. While shifting to lower operating voltages and more efficient circuit designs have helped to reduce heat loads, demands for enhanced performance and increased functionality on a single chip, will lead to higher heat fluxes. Such high thermal design heat flux is necessary to maintain lower operating temperatures, which ensure reliability and result in reduced gate delay and higher processor speed. Typically, a wall temperature of about 85° C. is considered the thermal design temperature limit for high performance memory and logic chips. Higher temperature limits may be appropriate for other devices.

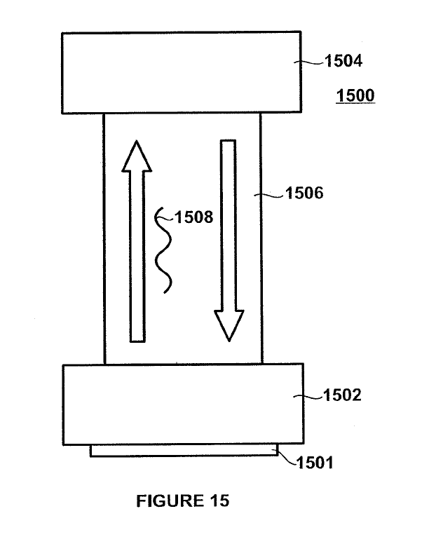

One way to manage this thermal load is with a heat pipe or thermosyphon. FIG. 15 shows a simplified schematic view of a conventional two-phase closed thermosyphon 1500. Such a thermosyphon 1500 comprises an evaporator 1502 in thermal communication with a heat source 1501, a condenser 1504, and an adiabatic section 1506 that allows a working fluid 1508 to travel between the evaporator and condenser. Vapor generated at the evaporator rises due to buoyancy forces, and then condenses at the top of the chamber at the condenser, releasing its latent heat. Gravity then returns the condensate back to the evaporator, and the process repeats.

In a specific application, a thermosyphon structure could be utilized to cool a microprocessor. In particular, heat generated by a microprocessor could be transferred to the evaporator of a thermosyphon that is bonded with a thin thermally conductive interface to the backside of the chip. At the evaporator, heat would vaporize a working fluid such as FC-72 or FC-87. Ultimately, heat from the microprocessor would be dissipated at the condenser.

While conventional approaches to heat management are useful, the increased power density and heat from operating microprocessors creates a need in the art for improved approaches for fabricating heat sink structures.

Embodiments of the present invention relate to a thermosyphon device which features a graphitic foam element disposed between a heat source and an evaporator such as a boiling chamber. The porosity of the graphitic foam element, may confer desirable properties to the thermosyphon device. Specifically, the graphitic foam may enhance liquid wicking, enlarge the available surface area available for dissipation, and enhance phase change of the working fluid.

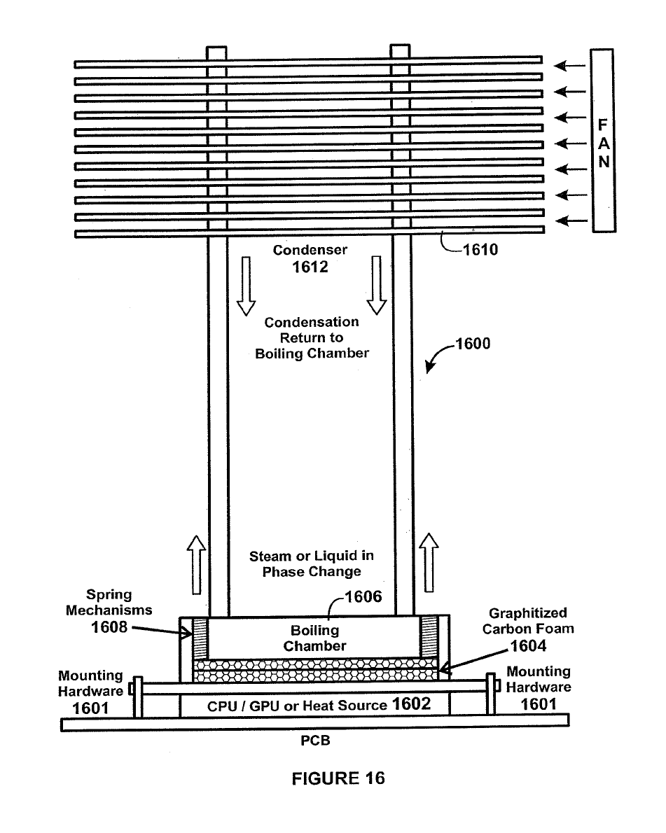

FIG. 16 shows a simplified view of an embodiment of an apparatus in accordance with the present invention. In the particular embodiment of FIG. 16, a modified heat pipe 1600 is mounted with mounting hardware 1601 on top of a heat source 1602, such as a central processing unit (CPU). Here, the heat pipe has been modified by placing a thin piece of graphitized carbon foam 1604 inside the boiling chamber 1606.

In this and other embodiments, boiling is enhanced because the open-celled structure of the graphitized-carbon foam allows low-boiling-point refrigerant in to wet the internal ligaments that provide numerous nucleation sites for boiling over a large surface area. For foam porosity of 80% or higher, and thermal conductivity of the graphite ligaments about four times that of copper, is necessary to conduct heat into the foam where nucleate boiling removes this heat into vapor that must escape from inside the foam.

The graphitized carbon foam 1604 can serve a number of functions. For example, the carbon foam 1604 enhances liquid wicking. Specifically, graphitized carbon wicks most liquids, which has the effect of recovering the surfaces of the foam and replacing liquid that has evaporated. This wicking has the effect of both increasing the wetted area over which boiling occurs, and increasing the temperatures at which film boiling occurs and at which elements burn out.

The carbon foam 1604 also enlarges the available surface area available for dissipation. In particular, graphitized carbon foams have internal surface areas of 2,000 to 50,000 m²/m³, which increase the sites available to nucleate boiling and thus increases the heat flux from the heated surfaces without burning out the element.

The carbon foam 1604 also enhances phase change of the working fluid. Specifically, graphitized foam also acts to enhance the phase change process by having more nucleation sites per unit surface area, and by having high conductivity which increases the surface temperature over an increased surface area.

The graphitic foam element offers a number of advantages, including but not limited to high conductivity, light weight, large surface area, low thermal storage, and corrosion resistance. These features combine to give the graphitic foam material favorable capabilities to increase heat transfer and decrease the energy consumed when cooling.

For example, the graphitic foam may offer high thermal conductivity. In particular embodiments the walls of the foam are nearly 4 times more conductive than copper, and eight times more conductive than aluminum. In one specific embodiment, the heat conductivity of the foam was measured to be above 1500 W/mK, as compared with 400 W/mK for copper, and 200 W/mK for aluminum. This means the surface of graphite foam is hotter than metal foam or fins. This property also allows heat to spread out over a larger surface area with the same thermal resistance.

Moreover, the graphitic foam is also lightweight. In particular embodiments, the density of foam is about 0.6 grams per cubic centimeter. such that heat spreaders formed from graphitized-carbon materials can weigh only 20% of those made from aluminum or copper. This property saves energy when the foam used for cooling on a moving part or in a moving vehicle.

The graphitic foam is also resistant to corrosion. Specifically, graphite is a relatively inert material, and does not corrode in oxidizing atmospheres below about 350° C. Moreover, coatings can be applied to elevate the temperature at which significant corrosion occurs.

Graphitic foam also offers low thermal storage properties. In particular embodiments, graphite foam stores 65% less heat per unit weight than copper. This property, in combination with the high thermal conductivity of graphitic foam mentioned above, means that the graphite foam can transport heat away from hot spots about 15 times faster than copper.

Graphitic foam may further offer a low coefficient of thermal expansion. Particular embodiments of graphitic foam in accordance with the present invention exhibit a coefficient of thermal expansion of about 2-4 micro-inches per inch per ° C. A bonding technique has been demonstrated in which prototype heat transfer remained constant during thermal cycling with temperature differences of over 300° C.

Graphitic foam may also offer a large surface area in compact volumes. For example, ratios of internal surface area per unit volume for embodiments of graphitic carbon, lie in the range 2,000 to 50,000 m²/m³. This allows large quantities of heat to be transferred by convection, condensation, evaporation or boiling, in relatively compact volumes.

A pressure device holds the carbon foam material against the interior wall of the boiling chamber nearest the heat source. Here, the pressure device comprises a spring mechanism 1608. In particular embodiments, no bonding material is required to attach the carbon foam, and the contact resistance is overcome by pressure only.

The central processing unit (CPU) is located underneath the enhanced boiling unit using with standard heat pipes mounted in the vertical direction. The air flow is horizontal across the aluminum fins 1610 of the condenser 1612.

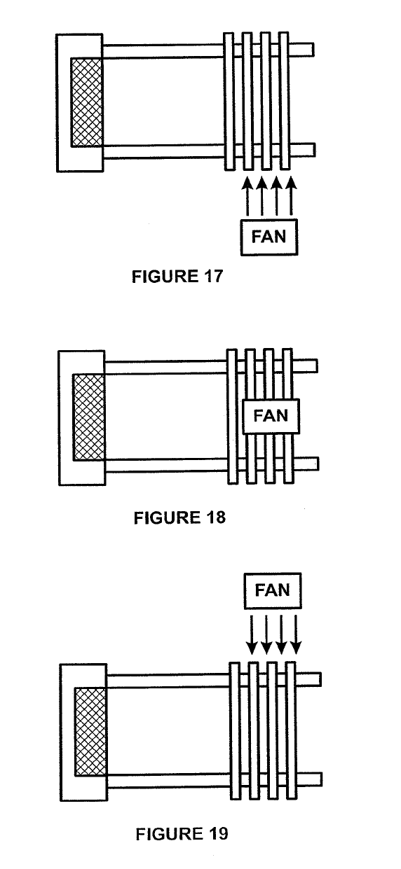

Other embodiments are possible. FIG. 17 shows a simplified cross-sectional view of an embodiment of a configuration representative of cooling a CPU mounted in a server or a telephony-switch power supply, the hot face of the CPU is vertical and the heat pipes are horizontal and attached on two sides of the heat spreader. A fan is located underneath, and the air flow is vertical through the aluminum fins.

In yet another embodiment representative of cooling a CPU mounted in a desktop computer, the hot face of the CPU is vertical, and the heat pipes are horizontal and are attached onto two sides of the heat spreader. Two of the heat pipes are attached at the top and at the bottom of the chip. The fan is at the side with air flow entering the aluminum fins horizontally. The CPU is contacted with the copper heat spreader of the heat sink, using clips supplied with the Freezer 4 heatpipe, available from Arctic Cooling Switzerland AG.

Several embodiments were tested, as summarized briefly below in the Table 2:

TABLE 2

| Embod. | FIG. | CPU | Heat Pipe | Fan | |
|---|---|---|---|---|---|
| No. | No. | Orientation | Orientation | Position | Air Flow |
| 1-1 | 16 | Horizontal | Vertical | to side | horizontal |
| 1-2 | 17 | Vertical | Horizontal | Underneath | Upward |
| 1-3 | 18 | Vertical | Horizontal | to side | horizontal |
| 1-4 | 19 | Vertical | Horizontal | Above | downward |

During testing of these embodiments, the fan was first turned on. Power was flowed to the chip. Five levels of power were applied.

The CPU case temperature (Tc) was measured by a Type K 26 gauge thermocouple attached onto the CPU simulator surface following the procedure specified by Intel in the Intel Pentium 4 Processor Thermal Design Guide, Thermal Specifications, 3.3.3 Processor Case Temperature Measurement Guideline. The air inlet temperature (tᵢₙ) was measured by a Type K thermocouple located about 1″ from the fan centre for the 16, 17, and 18 embodiments. For the FIG. 19 embodiment, the thermocouple was located about ¼″ from the fan blade and ¼″ from the motor of the fan.

The heat dissipation (Q) was determined by measuring the voltage (V) and current (A) applied to the CPU simulator. For each power level after the system reached thermal equilibrium, readings of the voltage, current, air inlet temperature, and CPU simulator surface temperature were taken.

The overall thermal resistance (R) was then determined by Equation (1):

$$R = \frac{Δ T}{Q} \qquad ( 1 )$$

where:

Q=VA; and (2)

ΔT=T_{c}−tᵢₙ (3)

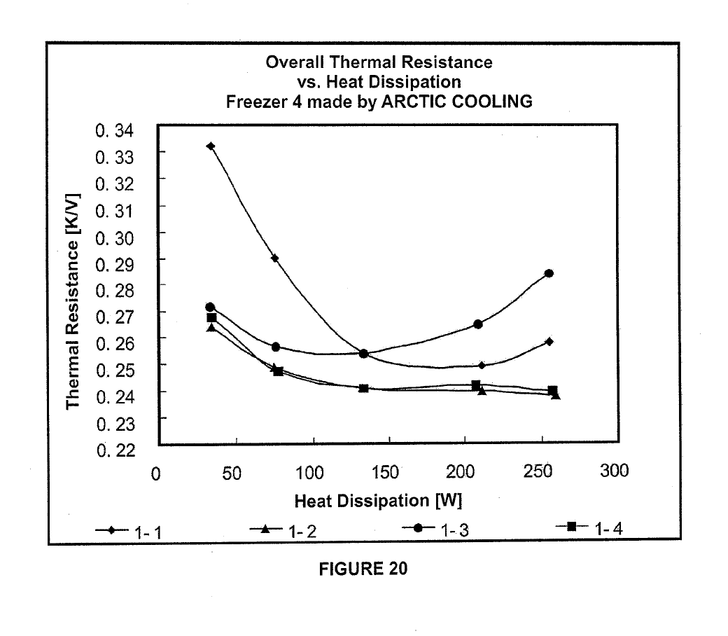

FIG. 20 plots the measured overall thermal resistances vs. heat dissipation for each of the four different embodiments that were tested. Results for embodiments 1-2 and 1-4 are identical because natural convection is negligible for the range of fan speeds tested.

FIG. 20 shows that vertical cooling is better than both horizontal flow and horizontal mounting. However, horizontal flow is preferable to horizontal mounting at power dissipation rates below 125 Watts. Horizontal mounting appears preferable at higher power levels.

FIG. 20 shows that with proper selection and configuration of foam to enhance boiling, thermal resistance has been decreased from 0.20° C./W in a commercial heatpipe, to 0.16° C./W according to an embodiment of the present invention. This represents a 25% reduction in the unit thermal resistance.

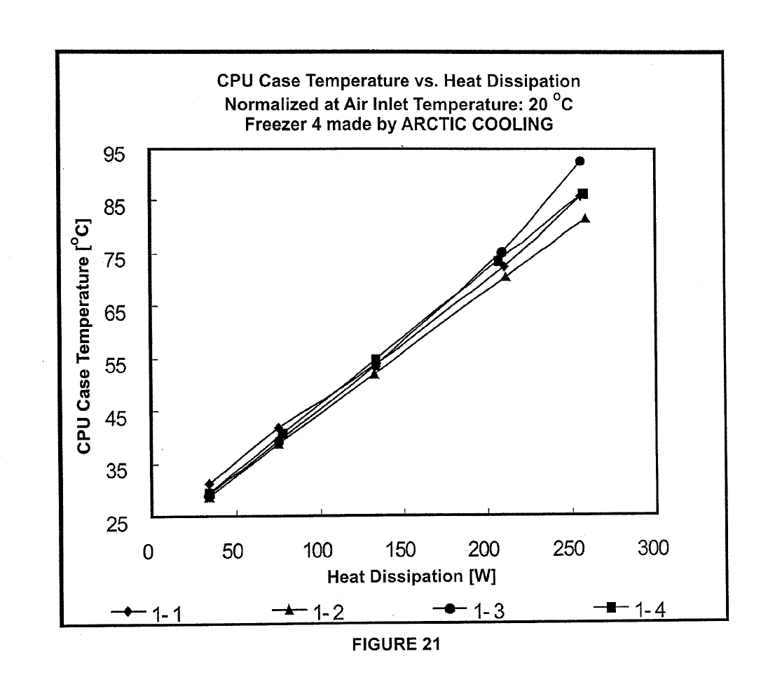

FIG. 21 shows the surface temperature (T_{c}) of the CPU microprocessor simulator at different power levels with the air inlet temperature normalized at 20° C. FIG. 21 shows wall temperature can be held below 85° C., while dissipating over 200 Watts. This outcome stands in contrast with an unaltered commercial device, where only up to 150 Watts can be dissipated.

The case temperature is higher for downward flow even though upward flow has almost identical overall thermal resistance. This is because of recirculating hot air back into the fan located on the top. Vertical mounting with flow from underneath, exhibits the lowest overall thermal resistance and lowest case temperature over the entire tested range. This is the orientation recommended by the manufacturer.

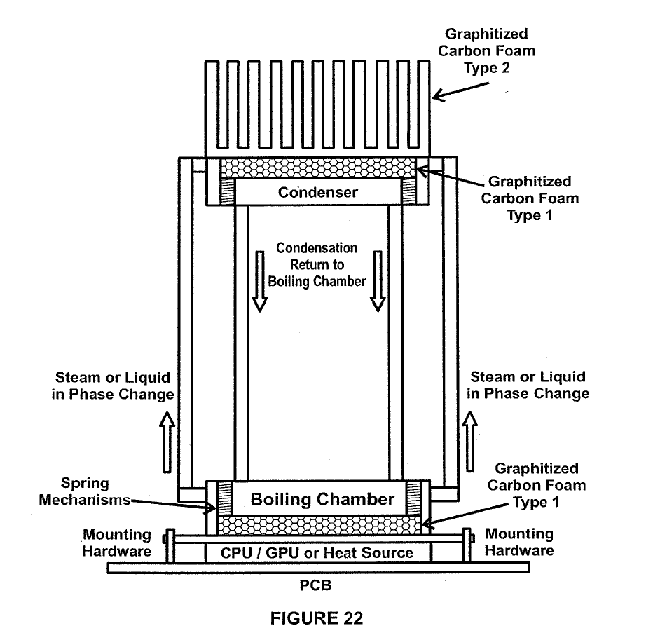

While the embodiments described above employed a condenser comprising aluminum fins, this is not required by the present invention. In accordance with alternative embodiments, the condenser could be made of a different material. For example, in the alternative embodiment of FIG. 22, the condenser is in thermal communication with a plurality of fins comprising grapitized carbon foam. Such graphitized carbon foam could be of the same type in communication with the boiling chamber, characterized by a high porosity of 60% or greater. Alternatively, the graphitized foam could be of a different type, characterized by low porosity of 20% or less.

In conclusion, embodiments of the present invention relate to apparatuses and methods allowing enhancement of boiling and condensation for a broad range of applications, including but not limited to heat pipes, HVAC, and heat-to-energy. Employing a graphitic foam element, the cycle rate of boiling and condensing resulting is increased to improve thermal performance. In the area of microelectronics, embodiments of the present invention can remove 25% more heat from a microprocessor footprint.

The above description has focused upon the use of a graphitic foam element for management of heat from a computer. However, embodiments in accordance with the present invention are not limited to that particular application. Alternative embodiments of the subject technology are also applicable in other contexts, including but not limited to heating, ventilation, and air conditioning (HVAC), and heat-to-energy applications.

1. An apparatus comprising: a graphitic foam element disposed to be in thermal communication with a heat source; an evaporator; an adiabatic section including a working fluid in thermal communication with the graphitic foam element; and a condenser in thermal communication with the adiabatic section.

2. The apparatus of claim 1 wherein the graphitic foam element exhibits a heat conductivity above 1500 W/mK.

3. The apparatus of claim 1 wherein the graphitic foam element exhibits a density of about 0.6 grams per cubic centimeter.

4. The apparatus of claim 1 wherein the graphitic foam element exhibits significant corrosion in oxidizing atmospheres only above about 350° C.

5. The apparatus of claim 1 wherein the graphitic foam element exhibits a coefficient of thermal expansion of about 2-4 micro-inches per inch per ° C.

6. The apparatus of claim 1 wherein the graphitic foam element exhibits a ratio of internal surface area per unit volume in the range of about 2,000 to 50,000 m2/m3.

7. The apparatus of claim 1 wherein the condenser further comprises graphitic foam.

8. The apparatus of claim 1 further comprising a fan configured to blow air to the condenser.

9. The apparatus of claim 1 wherein the graphitic foam element is in thermal communication with a microprocessor as the heat source.

10. A cooling method comprising disposing a heat source in thermal communication with a thermosyphon through a graphitic foam element, the graphitic foam element serving to enhance wicking of a working fluid, enlarge an available surface area available for dissipation of heat, or enhancing a phase change of the working fluid.

11. The cooling method of claim 10 wherein the graphitic foam element is secured to the heat source utilizing a securing mechanism.

12. The cooling method of claim 10 wherein the graphitic foam element is secured to the heat source by application with a pressure.

13. The cooling method of claim 10 wherein the graphitic foam element is secured to the heat source comprising a microprocessor.

14. The cooling method of claim 10 wherein the graphitic foam element exhibits a heat conductivity above 1500 W/mK.

15. The cooling method of claim 10 wherein the graphitic foam element exhibits a density of about 0.6 grams per cubic centimeter.

16. The cooling method of claim 10 wherein the graphitic foam element exhibits significant corrosion in oxidizing atmospheres only above about 350° C.

17. The cooling method of claim 10 wherein the graphitic foam element exhibits a coefficient of thermal expansion of about 2-4 micro-inches per inch per ° C.

18. The cooling method of claim 10 wherein the graphitic foam element exhibits a ratio of internal surface area per unit volume in the range of about 2,000 to 50,000 m2/m3.

Porous Graphitized-Carbon Foam Optimized for Performance

Embodiments of the present invention relate to methods and devices for optimization and cleaning of porous carbon materials. In particular embodiments, the methods and devices are designed to introduce hot reactants to oxidize the carbon material, and to move the reaction material in the form of gas, smoke, or soot. By removing lips of material at the interpore windows, and by rounding the sharp edges of the interpore windows, the diameter of interpore windows can be reduced by about 15% and the pressure drop across a power window can be reduced by about 40-50%. As heat transfer and structural loads in these lip regions are minimal, there is a negligible loss of strength and heat transfer in the porous foam by removal of this edge material.

Porous graphitized-carbon foam materials optimized for thermal performance, deliver cooling with the low energy consumption in a small and light package. Low energy consumption may be attained by simultaneous minimization of resistance to flow through the foam (hydraulic or aerodynamic resistance), and minimization of resistance to heat transfer from a surface to fluid flowing through the foam (thermal resistance). Energy consumption is also reduced by the low weight of the material, especially if mounted in cooling devices on moving parts or vehicles. A third factor in the optimization process is the strength of the material, which must be sufficient to withstand forces incurred when operating, mounting, and manufacturing a cooling device.

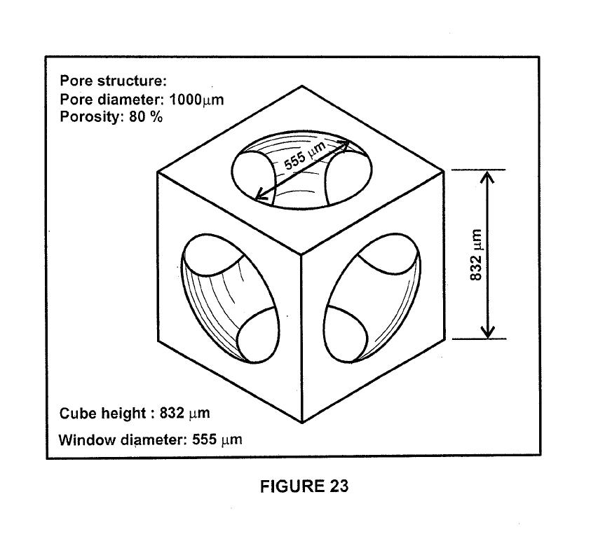

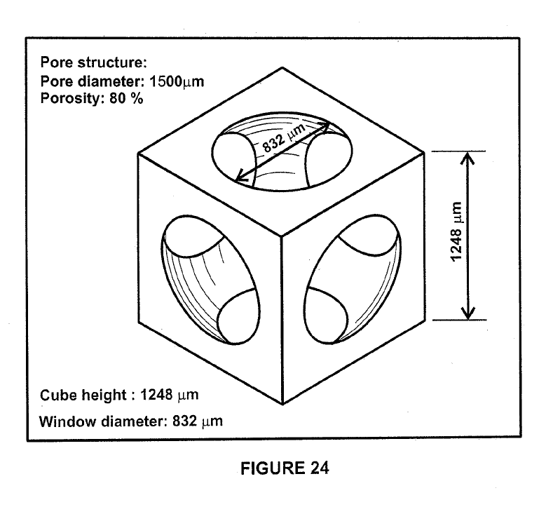

The optimal structure for a graphitized-carbon foam depends on both the diameter of pores in the solid material, and the thermal conductivity of the solid material. The strength of the foam depends on its porosity. FIGS. 23 and 24 show optimal diameters of interpore windows for two exemplar types of optimal graphitized-carbon foams. As discussed below and shown in Table 3, the different types of optimal graphitized carbon foams exhibit specific pore diameters, solid-phase thermal conductivities, and porosities:

TABLE 3

| | | Type 1 | Type 2 |
|---|---|---|---|
| | | Foam | Foam |
| Foam Property | Units | (FIG. 1) | (FIG. 2) |
| Pore diameter D | Um | 1000 | 1500 |
| Solid thermal conductivity kₛ | W/mK | 1000 | 1500 |
| Porosity | % | 80 | 80 |
| Ideal pore window diameter d | Um | 555 | 832 |
| Internal surface area to volume ratio □ | m²/m³ | 2700 | 1800 |

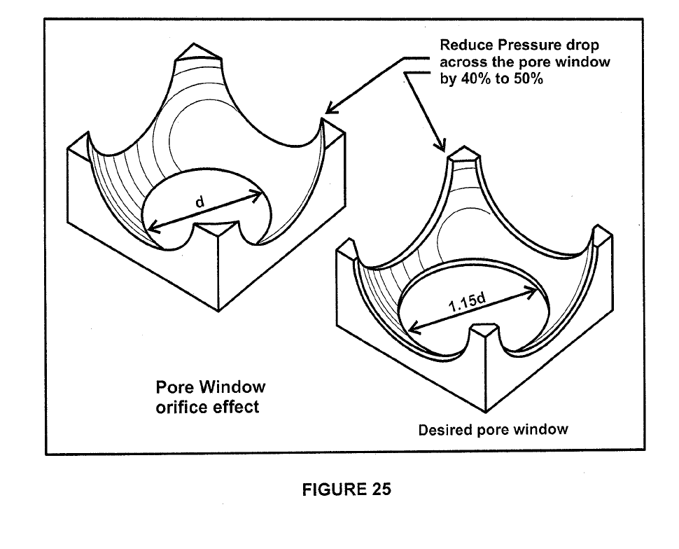

The optimal structures of the Type 1 and Type 2 foams shown in FIGS. 23 and 24, may be further improved by reduction of elimination of lips of the interpore windows. Specifically, FIG. 25 shows reduction of resistance to flow through the foam, by removal of thin material near the lip of the interpore windows, and by rounding the sharp edges of the interpore windows. As heat transfer and structural loads in these regions are minimal, there is a negligible loss of strength and heat transfer by removal of the edge material to increase the diameter of interpore windows by 15% as shown on FIG. 25.

Foam optimization according to embodiments of the present invention can be accomplished by introducing heated reactants to oxidize the carbon material, and then removing the reaction material in the form of gas, smoke, or soot. Desired permeability of the foam material can be obtained using a reactant heated to a variable temperature, and channeled through the foam via a sealed duct at a variable rate of velocity, while measuring the pressure drop across the foam material. In certain embodiments, the pressure drop across a power window can be reduced by about 40-50% as a result of the optimization process.

The selection of temperature, flow rate, and constituent reactants determine the rate of oxidation. The time for which the material is exposed is determined by the desired results of particulate elimination or permeability or both. Various reactant mixes may be used, and the heat source can be any source that may be readily and accurately controlled.

Embodiments of the present invention can optimize the porous material in one or more of the following ways. First, the properties of the material may be optimized by increasing the size of the pore windows. Second, the properties of the material may be optimized by reducing the number of jagged edges that cause undesirable turbulence in the working fluid passing through the material. Third, the material may be cleaned by eliminating fine loose particulate that results from cutting or machining the material.

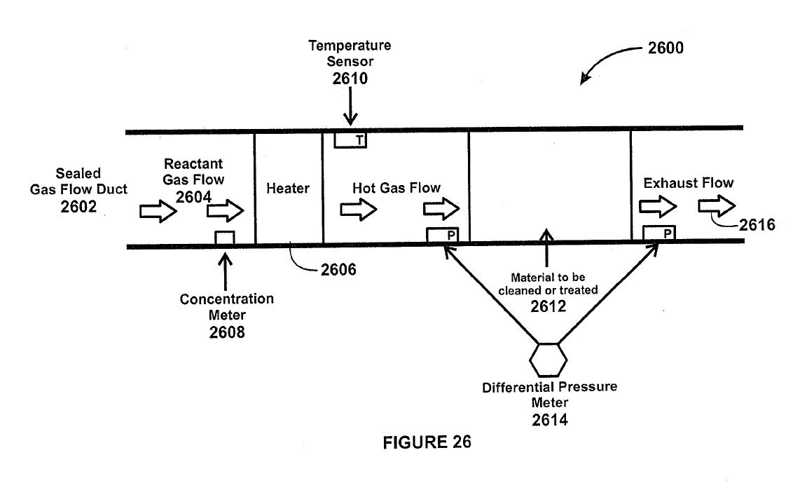

FIG. 26 shows a simplified schematic view of an embodiment of an apparatus in accordance with the present invention for performing the optimization of the material. Specifically, apparatus 2600 comprises a gas flow duct 2602 containing a reactant gas flow 2604. In a particular embodiment, the gas flow duct 2602 may be formed from a channel made of a phenolic composite such as garolite.

The reactant gas flow 2604 may comprise one or more components that are configured to react with a material that is to be cleaned or treated. In one embodiment, the reactant gas flow comprises air, but in other embodiments oxidants such as oxygen, ozone, or steam could alternatively be used. Concentration meter 2608 is positioned near the inlet of the duct and serves to confirm the composition of the reactant gas flow.

Heater 2606 is positioned within duct 2602. The reactant gas flow passing through heater 2606 experiences an increase in temperature. In a particular embodiment, the heater 406 may take the form of one or more cartridge heaters inserted into a copper block. The reactant gas flow comprising oxygen, water vapor, and/or carbon dioxide mixed into a flow of air, may be heated to a temperature of about 400° C. or greater.

Temperature sensor 2610 is positioned downstream of heater 2606. Temperature sensor serves 2610 to confirm the accurate temperature of the heated reactant gas flow.

The material 2612 that is to be cleaned or treated, is positioned within duct 2602, occupying its entire cross-section. The high-temperature reactant gas in the duct encounters and flows through the material 2612. As described above, during this flow though the porous carbon, the reactant gas removes thin material near the lip of the interpore windows, and rounds the sharp edges of the interpore windows.

The optimization process according to an embodiment of the present invention increases the permeability of the material, and results in a changed pressure drop across the material. Such a changed pressure drop can be detected utilizing differential pressure meter 2614.

An exhaust flow 2616 of the reactant gas exiting the material, continues to move down the duct. This exhaust flow may be subject to remediation such as filtering and/or washing to remove contamination, before being released into the environment.

While the above-referenced embodiment relates to optimization of a graphitic carbon foam utilizing a reactant gas flowed therethrough, this is not required by the present invention. According to alternative embodiments, graphitic foam could be optimized utilizing other approaches. For example, in certain embodiments, a flow of high concentration acid(s) that are boiling or superheated, can be used to oxidize the foam instead of an oxidizing gas.

According to still other alternative embodiments, a graphitic foam could be optimized through a process of electrochemical oxidation. In one embodiment, such electrochemical oxidation could be driven by application of an external voltage by an external electric circuit connected to an external reduction electrode in the fluid within the pores. In this approach, electrons are transferred between molecules, and oxidation of the carbon occurs to remove unwanted materials from the pore walls. The fluid inside the porous foam may be stationary, or may be configured to flow through the foam during this electrochemical process in order to preferentially remove the material on the pore walls around the interpore windows, that creates pressure losses.

The optimum porous graphitized-carbon foam was discovered as a result of the knowledge and understanding of the interdependence of mechanical properties, conduction phenomena, and convective heat transfer in foams made from graphitized-carbon materials. A combination of experimental and analytical engineering tools was used to investigate both mechanical and thermal phenomena, and the remainder of this section presents the salient findings based on these experiments and calculations.

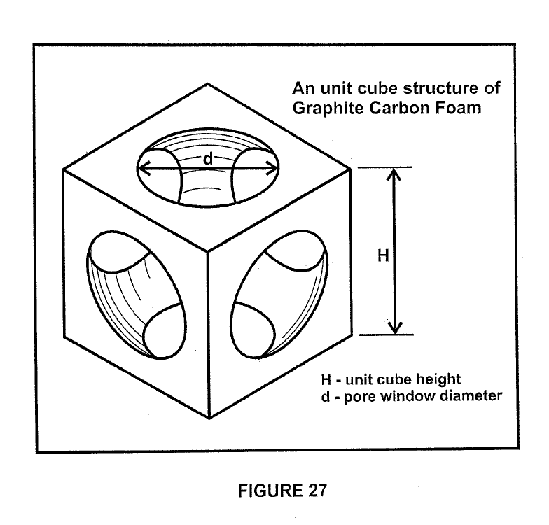

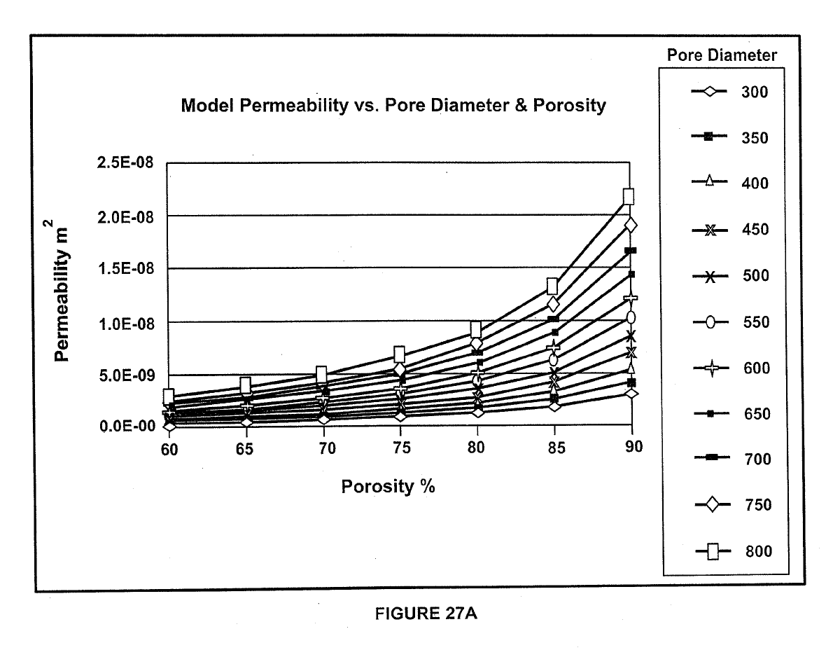

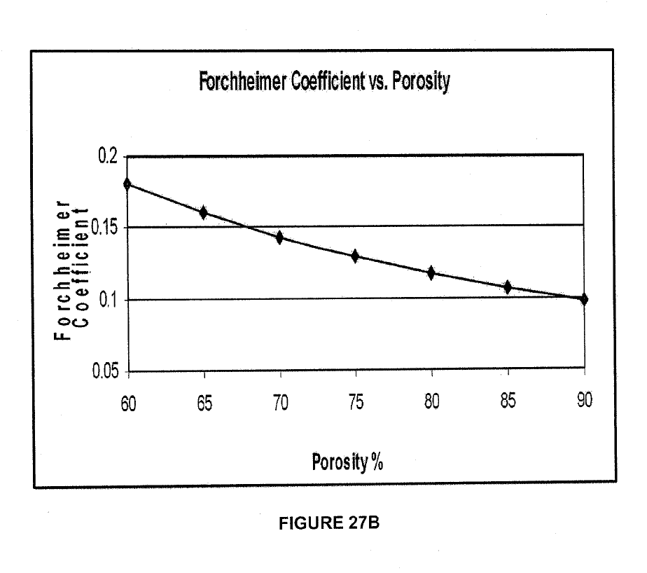

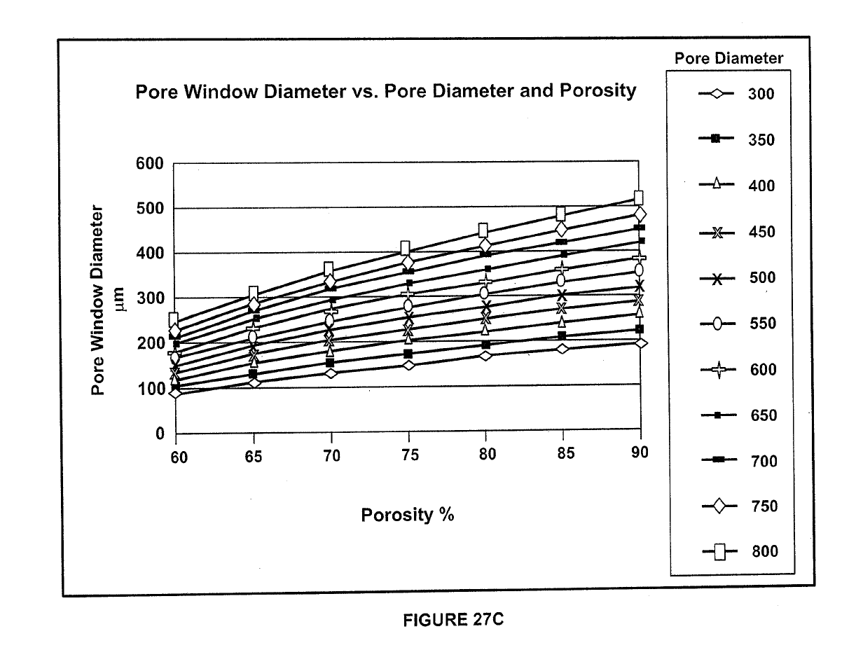

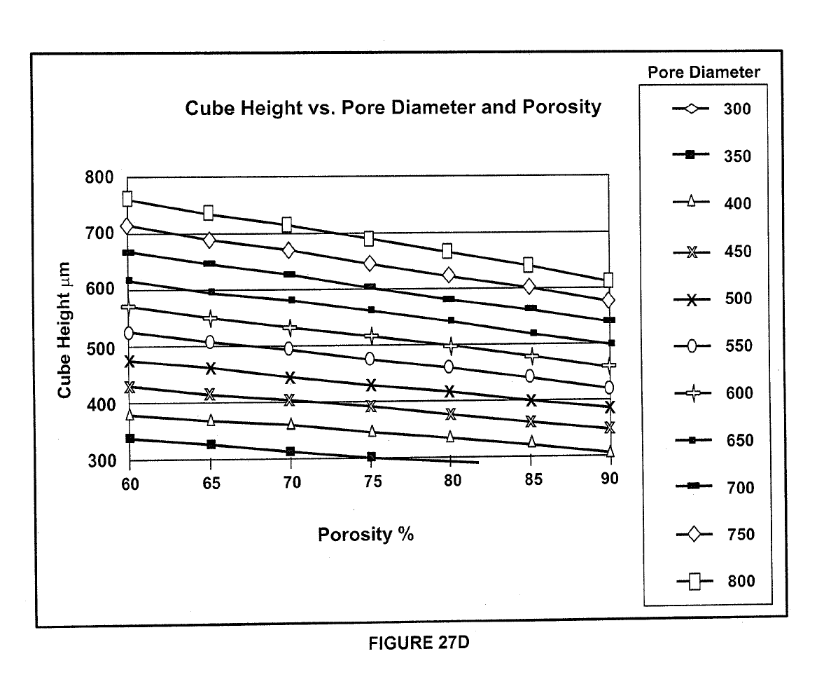

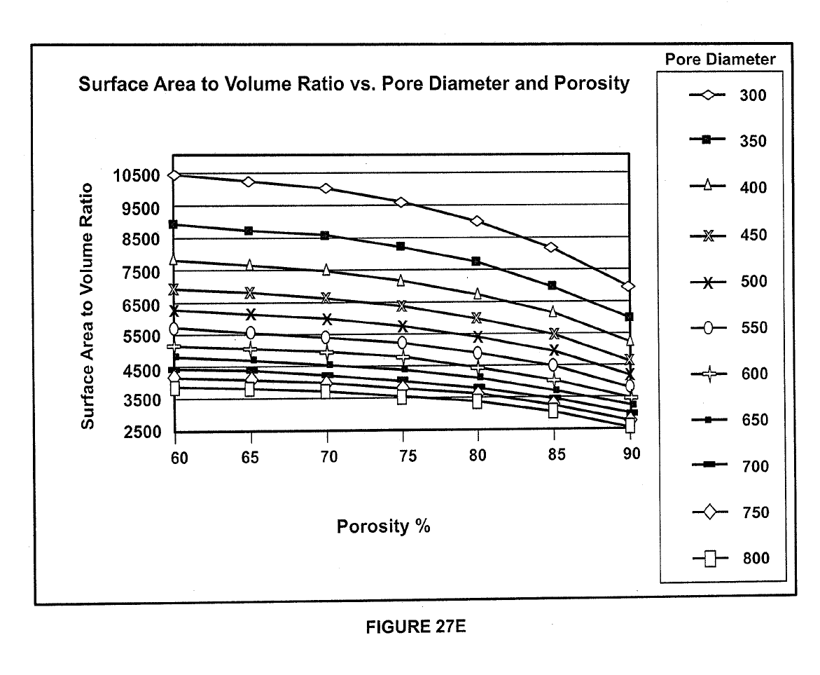

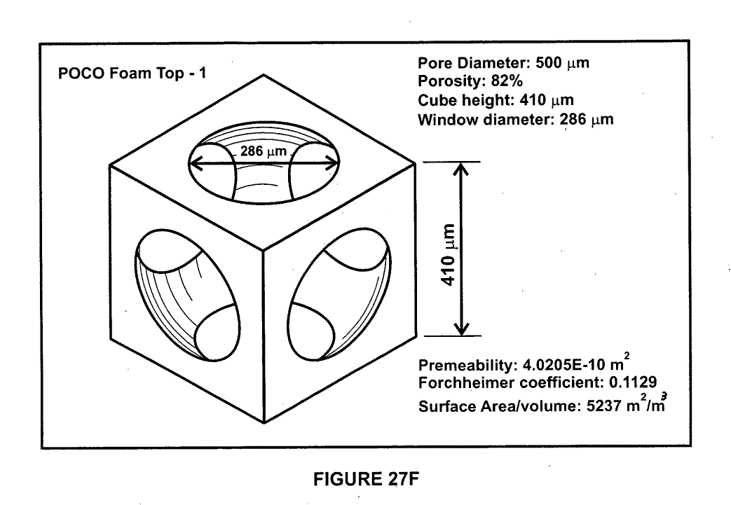

Measurements of pressure drop were obtained with large-scale versions of the unit-cube geometry as defined by Yu et al, “A Unit Cube-Based Model for Heat Transfer and Fluid Flow in Porous Carbon Foam”, Journal of Heat Transfer, Vol. 128, pp. 352-360 (April 2006), which is incorporated by reference herein for all purposes. FIG. 27 shows a generic representation of the unit cube model.

Use of the unit cube model allows prediction of various material properties based upon porosity. For example, FIG. 27A plots permeability versus porosity, for materials having different pore diameters. FIG. 27B plots Forchheimer coefficient versus porosity. FIG. 27C plots pore window diameter versus porosity, for materials having different pore diameters. FIG. 27D plots cube height versus porosity, for materials having different pore diameters. FIG. 27E plots the ratio of surface area to volume, versus porosity, for materials having different pore diameters.

FIG. 27F shows a representation of the unit cube of a graphitic foam (“POCO”) obtained from Poco Graphite, Inc. of Decatur, Tex. As indicated in FIGS. 23 and 24, embodiments of foam materials in accordance with the present invention can also be depicted in terms of the unit cube.

Behavior predicted by the unit cube model was used to in combination with actual measurements of heat flux, pressure drop, temperature rise, and flow rate, obtained with a gas or a liquid passing through over a hundred blocks of different graphitized-carbon foam materials. These graphitized-carbon foam materials were made to exhibit a wide range of solid-phase thermal conductivity, pore diameter, permeability, compressive strength, and interpore window diameters. Measured energy losses decreased continuously and non-linearly with increasing values of pore diameter, interpore window diameter, porosity, and radius of the lip of interpore windows.

Initial samples had gradients in the diameter of pores and windows. Such gradients are discussed by Straatman et al. in “Forced Convection Heat Transfer and Hydraulic Losses in Graphitic Foam”, Journal of Heat Transfer Vol. 129, pp. 1237-1245 (September 2007), which is incorporated by reference herein for all purposes. The following results were obtained with samples that had pore diameter and distributions of interpore windows that were uniform within 5% over the sample volume.

To allow comparison between different materials, measured values of dimensions and thermal properties for each sample were obtained, and then used to calculate the non-dimensional parameters representing heat transfer and friction factor that are presented below.

Measured results showed reduction in the component of thermal resistance associated with convective heat transfer when the surface area exposed to cooling fluid was increased. This increase in surface area also decreased the velocity of cooling fluid over the surface and reduced the associated energy losses due to surface friction.

Heat was distributed over a larger area when the thermal resistance of the pore walls decreased. This was accomplished either by making the pore walls thicker, or by increasing the conductivity of the graphitized carbon, especially in the direction perpendicular to the airflow. This is in contrast to a heat exchanger design that would increase the volume of foam to increase surface area, which would increase the size and cost of cooling devices that incorporate graphitized-carbon foams.

Experiments showed that increased thermal conductivity of graphitized-carbon materials increased the temperature of ligament surfaces over which the coolant flowed and thus proportionately decreased the thermal resistance associated with convective heat transfer. Higher the thermal conductivity of the solid ligaments was also measured to increase thermal performance of graphitized-carbon materials.

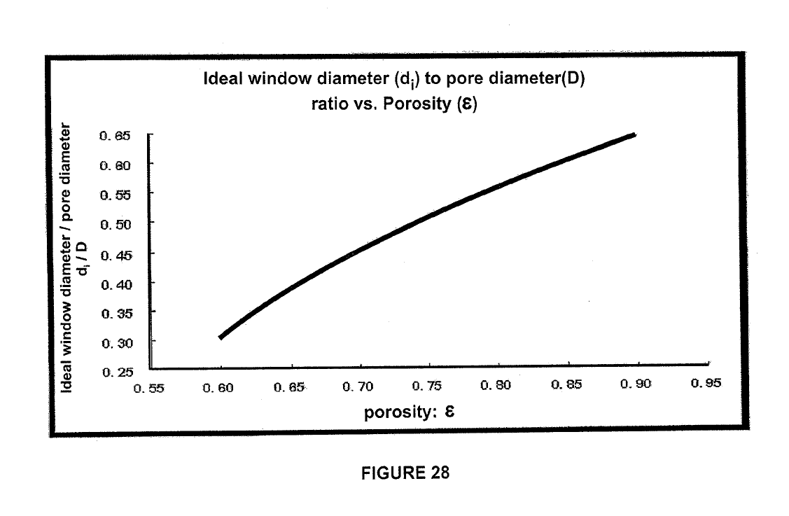

FIG. 28 plots ideal window diameter/pore diameter versus porosity, for the actual carbon foams. FIG. 28 shows the correlation between values of porosity for all of the foams tested with the ratio of pore diameter and interpore window diameter. Pore diameter is the measured mean value for the sample. The interpore window diameter was calculated from the unit-cube model mentioned above, utilizing measured values of permeability for each foam sample (FIG. 27A). An exponent series was fit to allow the experimental data to be interpolated and extrapolated over the range of porosities of interest to practical heat-exchanger design. The window/pore diameter results of FIG. 28 generally agree with the results of the unit cube model that are shown in FIG. 27C.

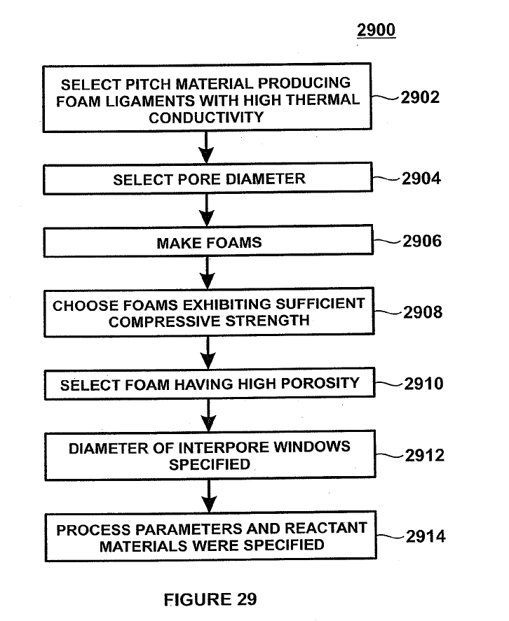

FIG. 29 is a simplified diagram showing the steps of a process flow 2900 for optimizing a porous graphitized-conductive foam material. In a first step 2902, pitch material that would produce foam ligaments with the highest thermal conductivity was selected. In a second step 2904, pore diameter was selected based on the flow rate through the foam, using conventional heat-exchanger designs that maximize heat transfer and minimize pressure rise.

In a third step 2906, several foams were made with a range of pitch mixtures and processing parameters. In a fourth step 2908, foam materials exhibiting sufficient compressive strength to carry the mechanical loads required for a specific application, were chosen. In the next step 2910, foam materials from this subgroup having the largest porosity, were selected.

In step 2912, the diameter of interpore windows was specified based on the experimental correlation shown on FIG. 28. Finally, in step 2914 the process parameters and source materials were adjusted to produce the optimal porous graphitized-carbon foam.

In one embodiment, over one hundred different foam materials were produced from a variety of mixtures of pitch materials and processing parameters. Mechanical testing showed graphitized-carbon foams of porosity of 70% to 80%, could be made to withstand compressive loads in excess of 50 psi. Accordingly, this was chosen as a reasonable minimum for a practical application to heatsinks and heat exchangers.

Further experiments have demonstrated that foams having a porosity of about 70-80% exhibit the least hydraulic resistance and sufficient strength to be practical. If the porosity of the foam material is over 80%, graphitized-carbon ligaments tend to fail under practical loads. If the porosity of the foam material is below 70%, the pressure drop increases detrimentally.

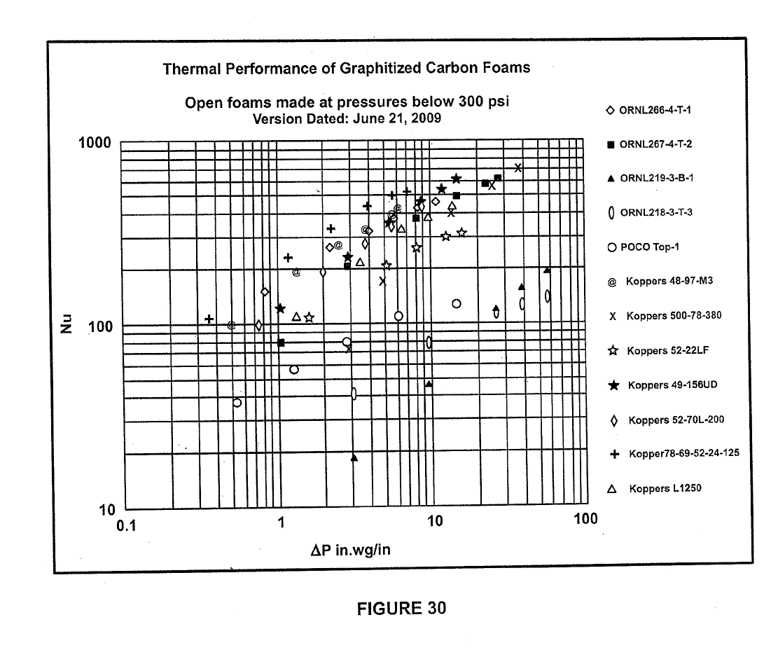

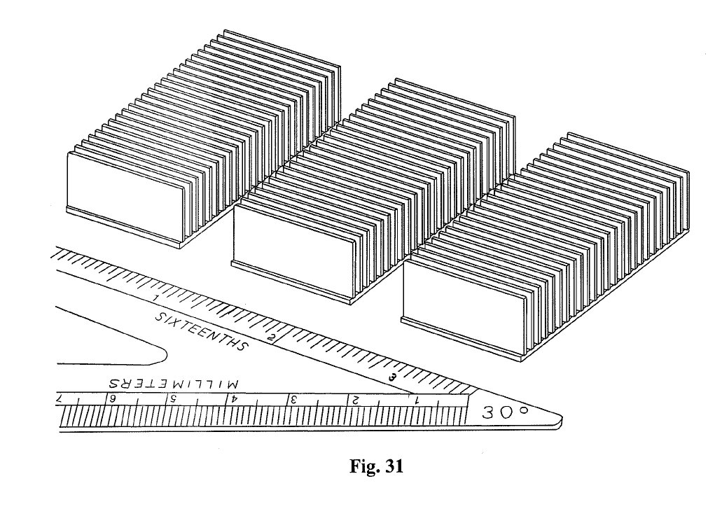

In heat transfer at a boundary (surface) within a fluid, the Nusselt number represents the ratio of convective to conductive heat transfer across (normal to) the boundary. FIG. 30 plots Nusselt number versus pressure drop for the POCO foam mentioned above, as well as a number of other foams obtained from Oak Ridge National Laboratory (ORNL) and Koppers Inc. of Pittsburgh, Pa. FIG. 8 shows the dependence of Nusselt number (which represents heat transfer from the foam to the fluid) on the pressure drop (which represents energy loss due to pumping).

The measured results of FIG. 30 were obtained utilizing the methodology spelled out by Straatman et al. However air (rather than water) was used as the fluid passing through the foam.

FIG. 30 shows that the optimum foam has the largest Nusselt number and least largest pressure drop (i.e. the largest heat transfer for least consumption of pumping energy). Although some of the other materials shown on FIG. 30 can be chosen for specific applications based on cost or strength, the smallest heat exchanger with the largest thermal effectiveness would be made with the materials labeled.

In a particular embodiment, the graphitic foam described herein could be used to manage heat from the microprocessor element of a computer. However, embodiments in accordance with the present invention are not limited to such an application. Alternative embodiments of the subject technology are also applicable in other contexts, including but not limited to heating, ventilation, and air conditioning (HVAC), and heat-to-energy applications.

1. A method comprising providing a carbon foam having a pore window; and forcing a heated reactant gas flow through the carbon foam to oxidize a lip of the pore window and thereby enlarge a size of the pore window.

2. The method of claim 1 wherein the carbon foam is disposed to occupy a cross section of a sealed gas flow duct.

3. The method of claim 1 wherein the carbon foam has a porosity of between about 70-80%.

4. The method of claim 1 wherein the pore size is enlarged by about 15% by exposure to the heated reactant gas flow.

5 The method of claim 1 wherein the carbon foam is configured to withstand a compressive load in excess of about 50 psi.

6 The method of claim 1 wherein a pressure drop across the carbon foam is reduced by between about 40-50% following enlargement of the pore window.

7 The method of claim 1 wherein the reactant gas flow comprises air, oxygen, carbon dioxide, and/or water vapor.

8 The method of claim 7 wherein the reactant gas flow is heated to about 400° C. or greater.

9. An apparatus comprising a sealed gas flow duct in fluid communication with a source of a reactant gas; a porous carbon foam material disposed to occupy a cross section of the sealed gas flow duct and to allow the reactant gas to flow therethrough; and a heater disposed upstream of the material and configured to heat the reactant gas prior to flowing through the material.

10. The apparatus of claim 9 further comprising:

a temperature sensor disposed between the heater and the porous carbon foam material.

11. The apparatus of claim 9 further comprising a differential pressure meter configured to measure a pressure drop across the porous carbon foam material.

12. The apparatus of claim 9 further comprising a concentration meter disposed upstream of the porous carbon foam material.

13. The apparatus of claim 9 wherein the porous carbon foam material exhibits a porosity of between about 70-80%.

14. A method comprising: providing a carbon foam having a pore window; and exposing the carbon foam to an acid to oxidize a lip of the pore window and thereby enlarge a size of the pore window.

15. The method of claim 14 wherein the acid is heated to a high temperature.

16. A method comprising: providing a carbon foam having a pore window; and exposing the carbon foam to electrochemical oxidation to oxidize a lip of the pore window and thereby enlarge a size of the pore window.

17. The method of claim 16 wherein the electrochemical oxidation is performed utilizing a working fluid present within a pore of the carbon foam.

18. The method of claim 17 wherein the working fluid is flowed through the pore during the electrochemical oxidation.

Dense Graphitized Carbon Foam

Dense graphitized-carbon materials according to embodiments of the present invention can be optimized for maximum thermal conductivity, minimal weight, maximum strength, and nearly isotropic properties. Embodiments of dense graphitized carbon foam are well-suited for use as heat spreaders, heat sinks, and heat-exchanger elements that transfer the largest amounts of heat while consuming the least energy to effect cooling. Such low energy consumption is attained by simultaneously minimizing both the resistance to flow over the surface (hydraulic or aerodynamic resistance), and the resistance to heat transfer from its surfaces (thermal resistance). Energy consumption may also be lowered by reducing the weight of the dense foam material, especially if mounted in cooling devices on moving parts or vehicles.

In the following detailed description, reference is made to the accompanying drawings which for a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the spirit and scope of the present invention.

Embodiments in accordance with the present invention relate to a dense grapitized carbon foam (GCF) material having desirable thermal properties. In certain embodiments, the GCF material has a porosity of about 25% or less, and in some cases about 20% or less. In a particular embodiment, the GCF material has a density of about 0.5 g/cm3 or greater. In a particular embodiment, the GCF material exhibits a bulk conductivity of about 400 W/(m·K). Particular embodiments of GCF material in accordance with the present invention may be formed under pressures of between about 800-1500 psi.

Incorporated by reference herein in its entirety for all purposes is the following text: Kays and London, “Compact Heat Exchangers”, McGraw Hill, 3rd Ed. (1984), which is incorporated by reference in its entirety herein for all purposes Attached hereto as an Exhibit and incorporated by reference, are presentation slides relating to graphitized carbon foam materials.

FIG. 31 is a photograph showing conventional finned heat sink structures made from steel (left) and copper (right), and shows an embodiment of a heat sink structure in accordance with the present invention made out of dense GCF material (center).

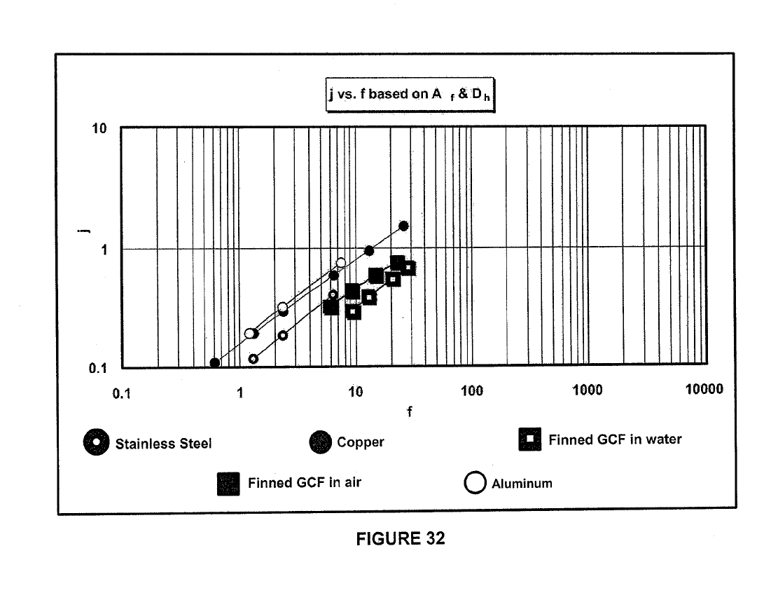

FIG. 32 shows the thermal performance of finned heat sink structures having fins made from various materials (metals, dense GCF foam). In particular, FIG. 32 plots heat energy transferred versus blower energy (losses), FIG. 32 shows that the thermal performance of the dense GCF foam heat sink structures to be comparable with the other materials. However, the weight of the dense GCF foam would likely be much less than the conventional metal structures, thereby lowering energy consumption where the heat sink is part of a moving element. Moreover, the dense GCF foam according to embodiments of the present invention would be expected to exhibit significantly greater resistance to corrosion than conventional metal structures.

Dense graphitized-carbon materials according to embodiments of the present invention may be comprised of an array of randomly orientated graphite crystals having minimal impurities. The random orientation of the crystals produces near isotropic properties, such as physical strength and electrical and thermal conductivity. Graphite crystals are well suited for this purpose because of their high conductivity and light weight. The minimization of impurities is important to reduce weight, and also to eliminate impediments to conductivity, particularly at the interface between crystalline structures.

Dense graphitized carbon materials according to embodiments of the present invention may be suitable for use in Faraday cages. In such applications, the dense foam material may be optimized for maximum electrical conductivity per unit weight. By contrast, when used for other applications such as elements for heating and boiling, electrical resistivity of the dense graphitized carbon material may be increased to facilitate Joule heating.

As indicated below, measurements show that heat sinks and heat exchanger elements made from dense graphitized-carbon materials according to embodiments of the present invention, can match the thermal performance of conventional finned heat sinks made from metals. Moreover, graphitized-carbon materials according to embodiments of the present invention can occupy the same volume while weighing only 10%, 20%, and 30% as those made from stainless steel, copper, and aluminum, respectively. In addition, elements made of graphitized-carbon exhibit favorable corrosion resistance as compared with those made from metal.

One possible advantage offered by dense graphitized carbon materials fins is higher thermal conductivity. In one example, this property would allow heat-exchanger elements to exhibit five (5) times more (cooled) fin area per unit (hot) surface area, than an equivalent structure having aluminum fins. This in turn allows the removal of five times the heat from the same footprint of a finned heat sink made out of aluminum (three times more than copper fins), or would require only one-fifth the number of aluminum heat exchanger tubes.

Another possible advantage offered by the dense graphitized-carbon fins is much lighter weight. Specifically, the dense graphitized carbon foam is one-fifth the weight of copper and one-third the weight of aluminum heat sinks or heat exchanger elements. Such light weight would desirably reduce the energy consumed by the heat sink, especially if it is mounted in cooling devices on moving parts or on vehicles.

A still further possible advantage offered by the dense graphitized-carbon according to embodiments of the present invention is higher surface temperature differences. Such higher surface temperatures could reduce the energy needed for cooling fans.

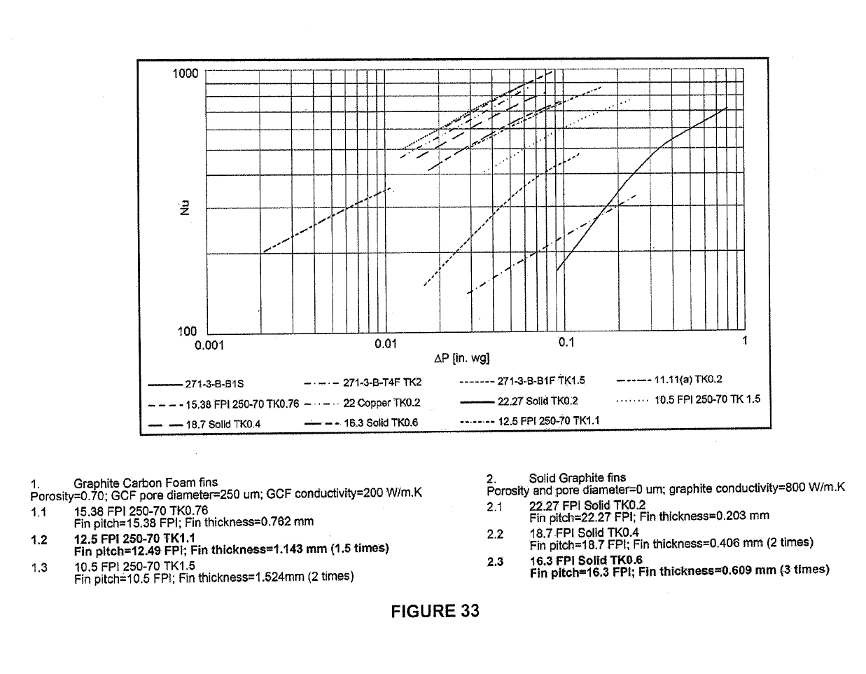

FIG. 33 shows estimates of thermal performance for various GCF heat sink structures. Foam structure was calculated utilizing a methodology incorporating a combination of theoretical and experimental findings to maximize heat transfer and minimize pressure drop. The thermal performance of this foam was estimated by extrapolating proprietary correlations of Nusselt number and pressure drop: Nusselt numbers were obtained from interpolation of measured heat transfer for foams whose structure bound the idealized structure; and pressure drop was measured with isothermal flow through scaled-up models of foams with the idealized structure.

1. An apparatus comprising a heat source; and a heat sink structure in thermal communication with the heat source, the heat sink comprising graphitized carbon foam having a porosity of about 25% or lower.

2. The apparatus of claim 1 wherein the graphitized carbon foam has a porosity of about 20% or lower.

3. The apparatus of claim 1 wherein the graphitized carbon foam has a density of about 0.5 g/cm³ or greater.

4. The apparatus of claim 1 wherein the graphitized carbon foam exhibits a bulk thermal conductivity of about 400 W/(m·K) or greater.

5. The apparatus of claim 1 wherein the heat sink structure comprises a fin.

6. The apparatus of claim 1 further comprising a device configured to flow a cooling fluid past the heat sink.

7. The apparatus of claim 6 wherein the device comprises a fan.

8. The apparatus of claim 6 wherein the cooling fluid comprises air.

9. A method of cooling a structure comprising placing a heat source in thermal communication with a heat sink structure comprising graphitized carbon foam having a porosity of about 25% or lower.

10. The method of claim 9 wherein the graphitized carbon foam has a porosity of about 20% or lower.

11. The method of claim 9 wherein the graphitized carbon foam has a density of about 0.5 g/cm³ or greater.

12. The method of claim 9 wherein the graphitized carbon foam exhibits a bulk thermal conductivity of about 400 W/(m·K) or greater.

13. The method of claim 9 further comprising flowing a cooling fluid past the heat sink to draw thermal energy therefrom.

14. The method of claim 13 wherein the cooling fluid comprises air.

This description has been provided to convey to those skilled in the art the information needed to apply the novel principles and to construct and use embodiments of the invention as required. However, it is to be understood that the invention can be carried out by specifically different devices and that various modifications can be accomplished without departing from the scope of the invention itself.

Thus while the above is a full description of the specific embodiments, various modifications, alternative constructions and equivalents may be used. Therefore, the above description and illustrations should not be taken as limiting the scope of the present invention which is defined by the appended claims.

What is claimed is:

1. A heat transfer assembly, comprising:
one or more foam elements having a major dimension and a minor dimension, each said element being made from bare, functionalized or surface coated graphitic foam based materials with a interconnected pore structure, said elements with a first and second opposed sides and a thickness defined between said first and second opposed sides, a heat exchange surface in thermal communication with the heat source and the first surface of said element whereby the graphitic ligaments of the first surface are in thermal contact with the exchange surface in at least two axial directions, a first cooling fluid at a first temperature divergent form a second temperature of the heat source, and at least one mechanical attachment mechanism which applies at one or more locations a force component on said element's second surface generally normal to the exchange surface, thus retaining relative disposition between said element heat exchange surface and the attachment mechanism to form a structurally compliant integral heat transfer assembly.

2. The heat transfer assembly of claim 1 wherein one or more foam elements is further defined as a plurality of planarly co-located elements in at least one direction with the edges of the elements extended on the exchange surface are generally a short distance from each other.

3. The heat transfer assembly of claim 1 wherein the exchange element coverage extends a distance beyond said exchange area.

4. The heat transfer assembly of claim 1 wherein the exchange element coverage extends a distance within said exchange area.

5. A heat transfer assembly, comprising:
a plurality of foam elements having a major dimension and a minor dimension of assembly, each said element being made from bare, functionalized or surface coated graphitic foam material with a interconnected pore structure, said elements with a first and second opposed sides and a thickness defined between said first and second opposed sides, at least one cooling fluid at a temperature divergent from that of the temperature of the heat source and the bulk material of said element a heat exchange surface in thermal communication with one or more heat sources, said exchange surface to be in mechanical thermal contact with the first or second element surface whereby the graphitic ligaments of given surface are in constant thermal contact with a force not to exceed the plastic deformation limit with an exchange surface in at least two axial directions, at least one mechanical attachment mechanism which applies at one or more locations a force component generally normal to the one or more exchange surfaces, thereby maintaining a structurally compliant integral heat transfer assembly.

6. The heat transfer assembly of claim 4 where plurality of elements is further defined as a plurality of stacked said elements with a physical barrier between stacked elements in one such axial direction extending substantially perpendicularly to said first and second opposed surfaces.

7. The heat transfer assembly of claim 5 wherein said barrier is from a group comprising a divider plate, a flat tube, and a heat spreader.

8. The heat transfer assembly of claim 5 wherein said force is applied from one or more directions generally normal to one or more heat exchange surface whereby a mostly consistent thermal contact impedance is obtained.

9. The heat transfer assembly of claim 5 where plurality of elements is further defined as a plurality of planarly co-located elements in at least one direction with the edges of the elements in extending generally a short distance from each other with additional one or more said stacked element with physical barriers between said stacked elements.

10. A method for transferring heat from a surface to a foam element conductively and to a cooling fluid convectively thereafter, wherein said element is in thermal communication with the heat source, said method comprising the steps of thermally attaching said foam element operably to said exchange surface, compressing foam material with a determined force and at one or more determined points.

11. A method of claim 10, wherein said heat transfer is by natural convection or forced convection to a cooling fluid.

12. The method of claim 10 wherein said element is located on a structure that is thermally coupled against at least some portion of one or more said source.

13. The method of claim 10 wherein said element is thermal coupled against at least one heat conducting surface.

14. The method of claim 10 wherein one or more heat exchangers are thermally coupled with said element.

15. The method of claim 14 wherein one or more said heat pipes are thermally coupled with said heat exchangers and one or more said elements.

16. The method of claim 10 whereby first surface is generally conformal to contact surface with said attachment mechanisms result in a tolerable thermal junction resistance in the absence of brazing, soldering, adhering of said element to the exchange surface.

17. The method of claim 10 whereby material compression against surface is produced by an attachment mechanism for forcing the element against the exchange surface, said attachment mechanism including one or more attachment mechanisms fixed relative to said heat source, each attachment mechanism having adjustable positions against the heat exchange surface.

18. The method of claim 17 wherein GF foam has the effective thermal conductivity is between 50 and 400 W/m·K and has an internal surface area of between about 1,100 and about 60,000 yards squared per cubic yard of foam.

19. A heat sink structure comprising:
a heat spreader in thermal communication with a heat source;
a graphitic foam element bonded to the heat spreader; and
an apparatus configured to force a thermal conducting fluid from the heat spreader through the graphitic foam element.

20. The heat sink structure of claim 19 wherein the graphitic foam element is bonded to the heat spreader utilizing pressure only.

21. The heat sink structure of claim 19 wherein the graphitic foam element is bonded to the heat spreader though an intervening material.

22. The heat sink structure of claim 19 wherein the heat spreader is selected from graphite, a graphite foam formed at high pressure, or a metal.

23. The heat sink structure of claim 19 wherein the apparatus comprises a fan positioned over a planar heat spreader, and the graphitic foam element comprises a wall formed perpendicular to a surface of the heat spreader.

24. The heat sink structure of claim 23 wherein the fan is configured to blow air as the thermal conducting fluid.

25. A heat sink structure comprising:
a base plate;
a cooling element configured to dissipate heat generated from the surface of an electronic device;
two clamping mechanisms including a first clamp, a second clamp, and a plurality of spring mechanisms, wherein the first clamp and the second clamp are arranged on opposite sides of the cooling element; and
wherein the plurality of spring mechanisms are used to attach the first clamp and the second clamp to the base plate;
wherein the cooling element is bondless and clamped in a fixed position between the first clamp and the second clamp through clamping pressure generated from the spring mechanisms.

26. The heat sink structure of claim 25, wherein the cooling element is a solid graphitic foam material.

27. The heat sink structure of claim 25, wherein the cooling element has two shorter sidewalls and two longer sidewalls.

28. The heat sink structure of claim 27, wherein the first clamp and the second clamp are arranged along the two shorter sidewalls of the cooling element.

29. The heat sink structure of claim 27, wherein the first clamp and the second clamp are arranged along the longer sidewalls of the cooling element.

30. A method comprising applying a bonding pressure to maintain a graphitic foam member in physical contact with an element, such that thermal energy is transferred from the element to the graphitic foam member.

31. The method of claim 30 wherein the bonding pressure is applied by a flow of a fluid against the graphitic foam member.

32. The method of claim 31 wherein the fluid is a temperature control medium configured to absorb thermal energy from the graphitic foam element.

33. The method of claim 30 wherein the pressure is applied as a mechanical force from a spring, lever, or clamp.

34. The method of claim 30 wherein the pressure is applied locally to the graphitic foam member.

35. The method of claim 30 wherein the pressure is applied globally to the graphitic foam member.

36. The method of claim 30 wherein the pressure is greater than 30 KPa and less than a fracture pressure of the graphitic foam member.
